(19) United States
(12) Patent Application Publication
(10) Pub. No.: US 2010/0260268 A1
(43) Pub. Date: Oct. 14, 2010

(54) Encoding, decoding, and distributing enhanced resolution stereoscopic video

(75) Inventors: Matt Cowan, Bloomingdale Providence Ontario (CA); Douglas J. McKnight, Boulder, CO (US); Bradley W. Walker, Dallas, TX (US); Mike Perkins, Louisville, CO (US); Michael G. Robinson, Boulder, CO (US)

Correspondence Address: REALD Inc. - Patent Department, by Baker & McKenzie LLP, 2001 Ross Avenue, Suite 2300, Dallas, TX, 75201, US

(73) Assignee: RealD Inc., Beverly Hills, CA (US)

(21) Appl. No.: 12/759,554

(22) Filed: Apr. 13, 2010

Related U.S. Application Data
(60) Provisional application No. 61/168,925, filed on Apr. 13, 2009.

(51) Int. Cl. H04N 7/12; H04N 13/00

(52) U.S. Cl. 375/240.25; 348/43; 375/E07.027; 348/E13.001

(57) ABSTRACT

This disclosure generally relates to stereoscopic images and stereoscopic video signals, and more specifically relates to encoding, distributing, and decoding stereoscopic images and stereoscopic video signals for use in television and high definition television systems, teleconferencing, picture phones, computer video transmission, digital cinema, as well as in other applications that include storage and/or transmission, over any suitable medium, of still or moving stereoscopic images, or combinations of moving and still stereoscopic images, in a form that is compatible with existing infrastructure, without requiring additional system functionality, while providing a means to allow higher resolution images to be distributed while maintaining compatibility with the existing infrastructure. The techniques hereof can be employed, for example, for distributing stereo 3D movies via optical disk, satellite, broadcast, cable, or internet, using current infrastructure, to consumers.

### CROSS-REFERENCE TO RELATED APPLICATIONS

This application claims priority to U.S. Provisional patent application Ser. No. 61/168,925, entitled “System and method for delivering full resolution stereoscopic images,” filed Apr. 13, 2009, which is herein incorporated by reference for all purposes.

### TECHNICAL FIELD

This disclosure generally relates to stereoscopic images and stereoscopic video, and more specifically relates to encoding, distributing, and decoding stereoscopic images and stereoscopic video using frame-compatible techniques through a conventional 2D delivery infrastructure.

### SUMMARY

This disclosure provides a method and system to deliver full-resolution stereoscopic 3D content to consumers that uses existing 2D distribution methods, such as optical disk, cable, satellite, broadcast, or internet protocol. The method includes the ability to provide enhanced image resolution characteristics by including an enhancement layer in the image stream received by the consumer. This enhancement layer is compatible with the currently popular approaches to image transport for consumers. Devices that receive 3D images in the home (e.g., disk players, set top boxes, televisions, etc.) may contain functionality to use the enhancement layer. High quality 3D images may also be received with no upgrade required to the consumer's hardware. In some cases, the enhancement layer is not used. The consumer may choose to upgrade his system and receive improved image quality by acquiring hardware and/or software that supports the additional functionality. In an aspect, an apparatus and technique to extract base layer data and enhancement layer data from the full resolution data; an apparatus and technique to compress the base and enhancement layer data; an apparatus and technique to transport the base and enhancement layer data within a standard MPEG structure; an apparatus and technique to re-assemble the base and enhancement layers into the full resolution data; and an apparatus and technique to convert the full resolution data to the preferred format, as supported by the user's display equipment, are disclosed. Conventional MPEG or VC1 compression techniques may be used to compress both the base layer and the enhancement layer. In an aspect, the reconstruction of a high-quality image from the base layer alone, without using the enhancement layer data, is disclosed.

According to an aspect, a method for encoding stereoscopic images includes receiving a stereoscopic video sequence, and generating stereoscopic base layer video and enhancement layer video from the stereoscopic video sequence. The method may further include compressing the stereoscopic base layer video to a compressed stereoscopic base layer, and compressing the stereoscopic enhancement layer video to a compressed stereoscopic enhancement layer. The stereoscopic base layer video may include a low-pass base layer, and a high-pass enhancement layer.

According to another aspect, a method for encoding a stereoscopic signal includes receiving a stereoscopic video sequence, and generating stereoscopic base layer video from the stereoscopic video sequence. The method also includes compressing the stereoscopic base layer video to a compressed stereoscopic base layer, generating stereoscopic enhancement layer video from the difference between the stereoscopic video sequence and the stereoscopic base layer video, and compressing the stereoscopic enhancement layer video to a compressed stereoscopic enhancement layer.

According to yet another aspect, an apparatus for selectively decoding stereoscopic content into standard resolution stereoscopic video or enhancement resolution stereoscopic video includes an extraction module and first and second decompressing modules. The extraction module is operable to receive an input bitstream and extract from the input bitstream compressed stereoscopic base layer video and compressed stereoscopic enhancement layer video. The first decompressing module is operable to decompress the compressed stereoscopic base layer video into stereoscopic base layer video. The second decompressing module is operable to decompress the compressed stereoscopic enhancement layer video signal into stereoscopic enhancement layer video.

Other features and aspects will be apparent from reading the detailed description, viewing the drawings, and reading the appended claims.

### BRIEF DESCRIPTION OF THE DRAWINGS

FIG. 1 is a schematic block diagram of an apparatus for encoding stereoscopic video, in accordance with the present disclosure;

FIG. 2 is a schematic block diagram of an apparatus for decoding stereoscopic video, in accordance with the present disclosure;

FIG. 3 is a schematic block diagram of another apparatus for encoding stereoscopic video, in accordance with the present disclosure;

FIG. 4 is a schematic block diagram of another apparatus for decoding stereoscopic video, in accordance with the present disclosure;

FIG. 5A shows a cardinal sampling grid and FIG. 5B shows its associated spatial frequency response, in accordance with the present disclosure;

FIG. 6 shows the spatial frequency response of an isotropic imaging system, in accordance with the present disclosure;

FIG. 7A shows a quincunx-sampling grid and FIG. 7B shows its associated spatial frequency response, in accordance with the present disclosure;

FIG. 8 shows an approximation of the human visual system frequency response, in accordance with the present disclosure;

FIG. 9A shows a cardinal sampling grid with reduced horizontal resolution and FIG. 9B shows its associated spatial frequency response, in accordance with the present disclosure;

FIG. 10A shows a cardinal sampling grid with reduced vertical resolution and FIG. 10B shows its associated spatial frequency response, in accordance with the present disclosure;

FIG. 11 is a schematic diagram showing a definition of odd and even quincunx sampling patterns, in accordance with the present disclosure;

FIG. 12 is a schematic diagram illustrating a process of horizontally squeezing quincunx sub-sampled images, in accordance with the present disclosure;

FIG. 13 is a schematic diagram illustrating a stereoscopic image processing encoding technique using quincunx-sub-sampled base and enhancement layers and 2D diamond convolution filters, in accordance with the present disclosure;

FIG. 14 is a schematic diagram illustrating a stereoscopic image processing decoding technique for a decoder using quincunx-sub-sampled base and enhancement layers and 2D diamond convolution filters, in accordance with the present disclosure;

FIG. 15 is a schematic diagram illustrating a stereoscopic image processing encoding technique using quincunx-sub-sampled base and enhancement layers and 2D diamond lifting discrete wavelet transform filters, in accordance with the present disclosure;

FIG. 16 is a schematic diagram illustrating a stereoscopic image processing encoding technique using quincunx-sub-sampled base and enhancement layers and 2D diamond lifting discrete wavelet transform filters, in accordance with the present disclosure;

FIG. 17 is a schematic diagram illustrating a stereoscopic image processing encoding technique using column-sub-sampled base and enhancement layers and 1D horizontal convolution filters, in accordance with the present disclosure;

FIG. 18 is a schematic diagram illustrating a stereoscopic image processing decoding technique using column sub-sampled base and enhancement layers and 1D horizontal convolution filters, in accordance with the present disclosure;

FIG. 19 is a schematic diagram illustrating a stereoscopic image processing encoding technique using column-sub-sampled base and enhancement layers and 1D vertical convolution filters, in accordance with the present disclosure;

FIG. 20 is a schematic diagram illustrating a stereoscopic image processing decoding technique using column sub-sampled base and enhancement layers and 1D vertical convolution filters, in accordance with the present disclosure;

FIG. 21 is a table showing an example of the coefficients of a 9×9 convolution kernel that implements a 2D diamond-shaped low-pass filter, in accordance with the present disclosure;

FIG. 22 shows a 1D example of a 2 band perfect reconstruction filter's frequency response, in accordance with the present disclosure;

FIG. 23 shows a 1D example of a 2 band perfect reconstruction filter's frequency response, modified for improved image quality, in accordance with the present disclosure;

FIG. 24 is a schematic block diagram of a 2D non-separable Lifting filter and coefficients, in accordance with the present disclosure;

FIG. 25 is a schematic diagram illustrating a stereoscopic image processing conversion technique from diamond low-pass filtered left and right images to line interleaved format, in accordance with the present disclosure;

FIG. 26 is a schematic diagram illustrating a stereoscopic image processing conversion technique from diamond low-pass filtered left and right images to column interleaved format, in accordance with the present disclosure;

FIG. 27 is a schematic diagram illustrating a stereoscopic image processing conversion technique from diamond low-pass filtered left and right images to frame interleaved format, in accordance with the present disclosure;

FIG. 28 is a schematic diagram illustrating a stereoscopic image processing conversion technique from full bandwidth left and right images to line interleaved format, in accordance with the present disclosure;

FIG. 29 is a schematic diagram illustrating a stereoscopic image processing conversion technique from full bandwidth left and right images to column interleaved format, in accordance with the present disclosure;

FIG. 30 is a schematic diagram illustrating a stereoscopic image processing conversion technique from full bandwidth left and right images to frame interleaved format, in accordance with the present disclosure;

FIG. 31 is a schematic diagram illustrating a stereoscopic image processing conversion technique from diamond low-pass filtered left and right images to DLP Diamond format, in accordance with the present disclosure;

FIG. 32 is a schematic diagram illustrating a stereoscopic image processing conversion technique from full bandwidth left and right images to DLP Diamond format, in accordance with the present disclosure;

FIG. 33 is a schematic diagram illustrating a stereoscopic image processing conversion technique from side-by-side diamond filtered left and right images to DLP Diamond format, in accordance with the present disclosure;

FIG. 34 is a schematic block diagram of a conventional ATSC broadcast system; and

FIG. 35 is a schematic block diagram illustrating the Transport Stream (TS) packetization process for a video Elementary Stream (ES), in accordance with the present disclosure.

GLOSSARY OF TERMS

| Term | Meaning |
|---|---|
| 2D | Two dimensional |
| 3D | Three dimensional or stereoscopic |
| ATSC | Advanced Television Systems Committee |
| AVC | Advanced Video Coding |
| BD | Bluray Disk |
| CMF | Conjugate Mirror Filters |
| DBS | Direct Broadcast System |
| DCT | Discrete Cosine Transforms |
| DFT | Discrete Fourier Transform |
| DLP | Digital Light Projection |
| DVD | Digital Versatile Disc |
| ES | Elementary Streams |
| HD | High Definition |
| HVS | Human Visual System |
| IDWT | Inverse Discrete Wavelet Transform |
| MPEG | Moving Picture Experts Group |
| MVC | Multiview Video Coding |
| PAT | Program Association Table |
| PES | Packetized Elementary Stream |
| PID | Packet ID |
| PMT | Program Mat Tables |
| PR | Perfect Reconstruction |
| PSI | Program Specific Information |
| PTS | Presentation Timestamps |
| PUSI | Payload Unit Start Indicator |
| QMF | Quadrature Mirror Filters |
| SEI | Supplemental Enhancement Information |
| SVC | Scalable Video Coding |
| TS | Transport Streams |
| VC1 | SMPTE 421M video codec standard |

### DETAILED DESCRIPTION

Stereoscopic (sometimes known as piano-stereoscopic) 3D images are created by displaying separate left and right eye images. These images can be delivered to the display in a number of ways, including as separate streams, or as a single multiplexed stream. In order to deliver as separate streams, the existing broadcast and consumer electronics infrastructure at both the hardware and software levels may be modified.

Significant infrastructure is already in place worldwide for delivering 2D images—including, but not limited to, systems employing optical disk (DVD, Blu-ray Disc, and HD DVD), satellite, broadcast, cable, and internet. These systems are able to handle specific types of compression, such as MPEG-2, MPEG-4/AVC, or VC1. These systems are targeted towards 2D imagery. Current multiplexing systems place the stereoscopic image pair into a 2D image which can be handled by the distribution system as a simple 2D image, as disclosed by Lipton et al in U.S. Pat. No. 5,193,000, which is herein incorporated by reference. At the display, the multiplexed 2D image can be demultiplexed to provide separate left and right images.

Existing signaling systems may indicate whether a given frame in a temporally multiplexed (frame or field interleaved) stereoscopic image stream is a left image, a right image, or a 2D (mono) image, as disclosed by Lipton et al in U.S. Pat. No. 5,572,250, which is herein incorporated by reference. These signaling systems are described as ‘in-band,’ meaning they use pixels in the active viewing area of the image to carry the signal, replacing the image visual data with the signal. This may result in a loss of up to one or more lines (rows) of image data.

There are several approaches to multiplexing to put the stereoscopic pair into a single image frame. One approach is to sub-sample each of the left and right frames, and pack each into one-half of the physical pixels available in a 2D frame. This sub-sampling could be in the horizontal, vertical, or diagonal direction. In the case of vertical or horizontal sub-sampling, the resulting image resolution does not retain equal horizontal and vertical resolutions, resulting in perceived image quality loss.

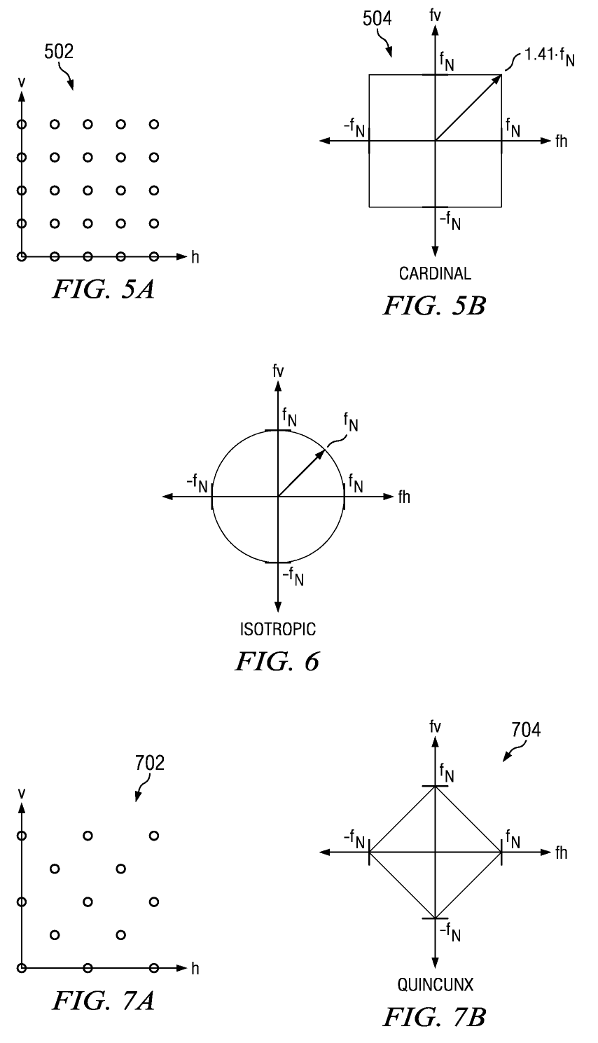

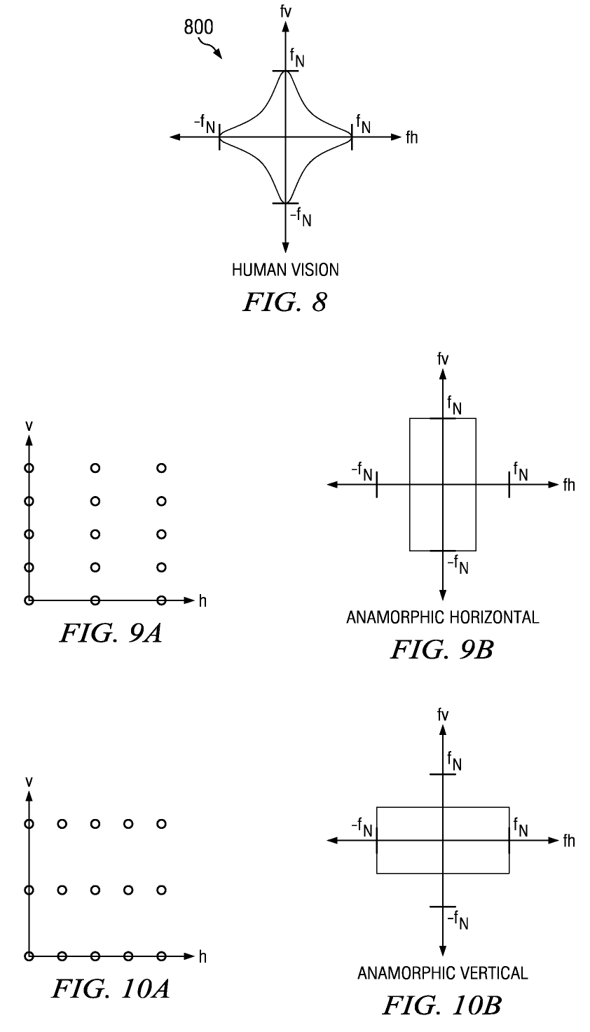

Current television practice uses cardinal (or Cartesian) sampling, with pixels arranged in horizontal rows and vertical columns, typically with similar horizontal and vertical spacing (e.g. ‘square pixels’). FIG. 5A shows a cardinal sampling grid and its associated spatial frequency response. Cardinal sampling produces a spatial frequency response that is not isotropic—it has higher resolution diagonally than either horizontally or vertically, by a factor of \sqrt{2}, or about 1.41, as shown in FIG. 5B. Human vision, however, is more sensitive to horizontal and vertical details. FIG. 8 shows a human visual system (HVS) frequency response. FIG. 6 shows a true isotropic resolution, which would result in a circular spatial frequency response. FIG. 9A shows a cardinal sampling grid with reduced horizontal resolution and its associated spatial frequency response and FIG. 10A shows a cardinal sampling grid with reduced vertical resolution and its associated spatial frequency response.

One alternative approach is to sample images diagonally, also referred to as quincunx sampling. FIG. 7A shows a quincunx sampling grid, and FIG. 7B shows a quincunx sampling frequency response. Quincunx sampling uses half the number of pixels to represent the image as compared to cardinal sampling. In this approach, the spatial frequency response has the shape of a diamond, with the vertical and horizontal resolutions equal to the cardinal sampling case. The diagonal resolution is reduced to about 0.70 of the horizontal and vertical resolutions. Note that the horizontal and vertical resolutions are an exact match to cardinal sampling; only the diagonal resolution is reduced.

Diagonal sampling takes advantage of the fact that a cardinally sampled image is over-sampled in the diagonal direction, relative to horizontal and vertical directions. In addition, human visual acuity in the diagonal direction is significantly less than in the vertical and horizontal directions, as shown in FIG. 8. Sub-sampling a Cartesian sampled image and eliminating pixels in a diagonal direction results in imagery that is close to visually lossless, as disclosed by Dhein et al in U.S. Pat. No. 5,159,453 and by Dhein et al in “Using the 2-D Spectrum to Compress Television Bandwidth” 132^{nd} SMPTE Technical Conference, October 1990, herein incorporated by reference.

With certain unusual images (e.g., single-pixel checkerboard test pattern), diagonal sampling may reduce visual image quality, resulting in a desire to recapture the lost quality. This problem has been addressed by several alternate methods. MPEG-2 Multiview (ITU-R Report BT.2017) and, more recently, Multiview Video Coding (MVC, ISO/IEC 14496-10:2008 Amendment 1) have addressed carrying multiple image streams in the H.222.0/MPEG-2/Systems transport stream.

By compressing a principal stream in the normal way, and encoding the differences between the principal stream and the additional stream or streams, better compression may be realized by taking advantage of the redundancy between images. Both these approaches have limited applicability to the existing infrastructure of 2D distribution. The principal image stream will be carried and displayed as a 2D stream, while the additional information to create additional streams will be ignored. To support the additional image streams, decoder functionality in the disk player, set top box, or television should support the multi-view functionality. This is not supported in the currently installed base. For successful adoption of any new system, it should be, to an extent, compatible with existing infrastructure, so the consumer is not obliged to purchase entirely new hardware. Compression systems discussed include:
1. MPEG-2/System: formally ISO/IEC 13818-1 and ITU-T Rec. H.222.0
2. MPEG-2/Video: formally ISO/IEC 13818-2 and ITU-T Rec. H.262
3. MPEG-2 Stereoscopic Television/Multi-view Profile: formally Report ITU-R BT.2017
4. MPEG-4/AVC formally ISO/IEC 14496-10 and ITU-T Rec. H.264
5. MPEG-4 Multiview Video Coding (MVC, ISO/IEC 14496-10:2008 Amendment 1)
6. VC1: formally SMPTE 421M video codec

In July 2008, MPEG officially approved an amendment of the ITU-T Rec. H.264 and ISO/IEC 14496-10 Advanced Video Coding (AVC) standard on Multiview Video Coding.

The MPEG committee has defined three sets of standards to date: MPEG-1, MPEG-2, and MPEG-4. Each standard comprises several parts dealing with separate issues such as audio compression, video compression, file formatting, and packetization.

Significant MPEG standards with respect to storage and transmission are the following:
7. MPEG-2 Part 1: Systems
8. MPEG-2 Part 2: Video
9. MPEG-4 Part 10: Video, including AVC, SVC, and MVC extensions
10. Stereoscopic Television MPEG-2 Multiview Profile

SMPTE and Microsoft have defined VC1, which is also known as SMPTE 421M. Other groups have used these fundamental MPEG and VC1 standards as building blocks to define application specific standards relevant to video storage and transmission including:
11. The Blue Ray Disc Association (BDA) (www.blu-raydisc.com)
12. The Advanced Television Systems Committee (ATSC) (www.atsc.org)
13. The Digital Video Broadcasting Project (DVB) (www.dvb.org)
14. DVD and HD-DVD

The MPEG-2 standard, ISO 13818, contain three critical parts concerning transmitting compressed multimedia signals: Audio (13818-3), Video (13818-2), and Systems (13818-1). The audio and video parts of the standard specify how to generate audio Elementary Streams and video Elementary Streams (ESs). In general, ESs are the output of video and audio encoders prior to packetization or formatting for transmission or storage. ESs are the lowest level streams in the MPEG standard.

An MPEG-2 video ES has a hierarchical structure with headers at each structural level. The highest-level header is the sequence header, which carries information such as the horizontal and vertical size of the pictures in the stream, the frame rate of the encoded video, and the bitrate. Each compressed frame is preceded by a picture header, whose most important piece of information is the picture type: I, B, or P frame. I-frames can be decoded without reference to any other frames, P frames depend on temporally preceding frames, and B frames depend on both a temporally preceding and a temporally subsequent frame. In MPEG-4/AVC, B frames can depend on multiple temporally preceding and temporally subsequent frames.

For purposes of motion compensated prediction, frames are sub-divided into macroblocks of size 16×16 pixels. In the case of P frames, a motion vector can be sent for each macroblock as part of its coded representation. The motion vector will point to an approximating block in a previous frame. The coding process takes the difference between the current block and the approximating block and encodes the result for transmission.

The difference signal may be encoded by computing Discrete Cosine Transforms (DCT) of 8×8 blocks of pixels, quantizing the coefficients with an emphasis on the low frequencies, and then losslessly encoding the quantized values.

The Systems portion of the MPEG-2 standard (Part 1) specifies how to combine audio and video ESs together. Two important problems solved by the systems layer are clock synchronization between the video encoder and the video decoder and presentation synchronization between the ESs in a program.

Encoder/decoder synchronization may prevent frames from being repeated or dropped and ES synchronization may help to maintain lip sync. Both of these functions are accomplished by the insertion of timestamps. Two types of timestamps may be used: system clock timestamps and presentation timestamps. The system clock—which is locked to the frame rate of the video source—is sampled to create system clock samples, while individual audio and video frames are tagged with presentation timestamps indicating when the frames should be presented with respect to the system clock.

MPEG-2 Part 1 specifies two different approaches to creating streams, one optimized for storage devices, and one optimized for transmission over noisy channels. The first type of system stream is referred to as a Program Stream and is used in DVDs. The second system stream is referred to as a Transport Stream. MPEG-2 Transport Streams (TS) are the more important of the two. Transport Streams are the basis of the digital standards employed for cable transmission, ATSC terrestrial broadcasting, satellite DBS systems, and Blue-ray Disc (BD).

FIG. 34 is a schematic block diagram of a conventional ATSC broadcast system. DVD uses Program Streams because program streams are slightly more efficient in terms of stream overhead and they minimize the processing power used to parse the stream. However, one of the design goals of BD was to enable real-time direct to disk recording of digitally transmitted TV signals. The use of TSs eliminates the need for BD recorders to transcode system formats in real-time while recording.

When packetizing Audio and video ESs into MPEG-2 transport streams, the ES data is first encapsulated in Packetized Elementary Stream Packets (PES packets). PES packets may be of variable length. PES packets begin with a short header and are followed by ES data. Arguably, the most important pieces of information carried by the PES header are the Presentation Timestamps (PTSs). PTSs tell the decoder when to present an audio or video frame with respect to the program clock. One common packetization approach, mandated in the ATSC standard, is to encapsulate each video frame in a separate PES packet.

PES packets are then segmented into smaller chunks and mapped into the payload section of TS packets. TS packets are 188 bytes in length with a maximum payload of 184 bytes per packet. Many TS packets are normally used to convey a single PES packet. The four byte TS packet header begins with a sync byte and also contains a packet ID (PID) field and a “payload unit start indicator” (PUSI) bit. The PUSI bit is used to flag the start of a PES packet in a TS packet. All data from a given ES is carried in packets of the same PID. When a PES packet header occurs in a TS packet, the PUSI bit is set and the PES header begins in the first byte of the payload. The decoder can strip away the TS packet headers and the PES headers to recover the raw ES.

Finally, TS packets occasionally contain an adaptation field—an extra field of bytes immediately after the four byte TS header, the presence of which is flagged by a bit in the TS header. Arguably the most important piece of information contained in this adaptation field is samples of the system clock. These samples may be inserted at least 10 times per second. The decoder may use these samples to lock its local clock to the clock of the encoder.

Many different ESs can be multiplexed together by time division multiplexing of the TS packets that carry them. The packets can be demultiplexed at the decoder by grabbing just the packets with the PIDs that carry the desired ESs. The fixed length TS packets are easy to synchronize to, because the first byte of the TS header is usually 0x47.

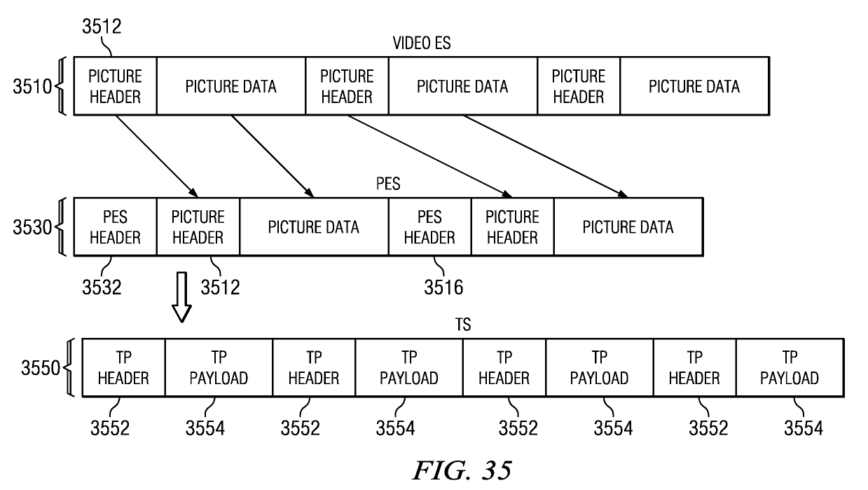

FIG. 35 illustrates the Transport Stream (TS) packetization process for a video Elementary Stream (ES). For an ATSC stream each picture 3510 is encapsulated in a single PES packet 3530. The picture header 3512 will occur after the start of the PES header 3532 and the PES header 3516 will carry the PTS for that picture. The PES packets 3530 are then mapped 184 bytes at a time into the payload section 3554 of TS packets 3550. Assuming the video stream has been chosen to carry the system clock samples for the program, the TP Header 3552 of selected video packets will be augmented with a few extra bytes to carry these samples.

A decoder should be able to analyze incoming TSs and determine what programs are present in the stream. Ultimately, the decoder should also be able to determine which PIDs carry the ESs that compose a program. To accomplish this, MPEG TSs carry Program Specific Information (PSI). PSI comprises two main tables—the Program Association Table (PAT) and the Program Map Tables (PMT). A TS typically only has one PAT, which is found on PID 0. PID 0 is therefore a reserved PID that should be used to carry this table. A decoder may start analyzing a packet multiplex by looking for PID 0. The PAT, once received and parsed from the PID 0 packets, tells the decoder how many programs are carried by the TS. Each program is further defined by a PMT. The PAT also tells the decoder the PID of the packets that carry the PMT for each program in the multiplex.

Once a desired program has been selected, the decoder parses out the PMT for the chosen program. The PMT for a given program tells the decoder (1) how many ESs are part of this program; (2) which PIDs carry these ESs; (3) what type of stream is each ES (audio, video, etc.); and (4) which PID carries the system time clock samples for this program. With this information, the decoder may parse out all the packets carrying streams for the chosen program and route the stream data to the appropriate ES decoders.

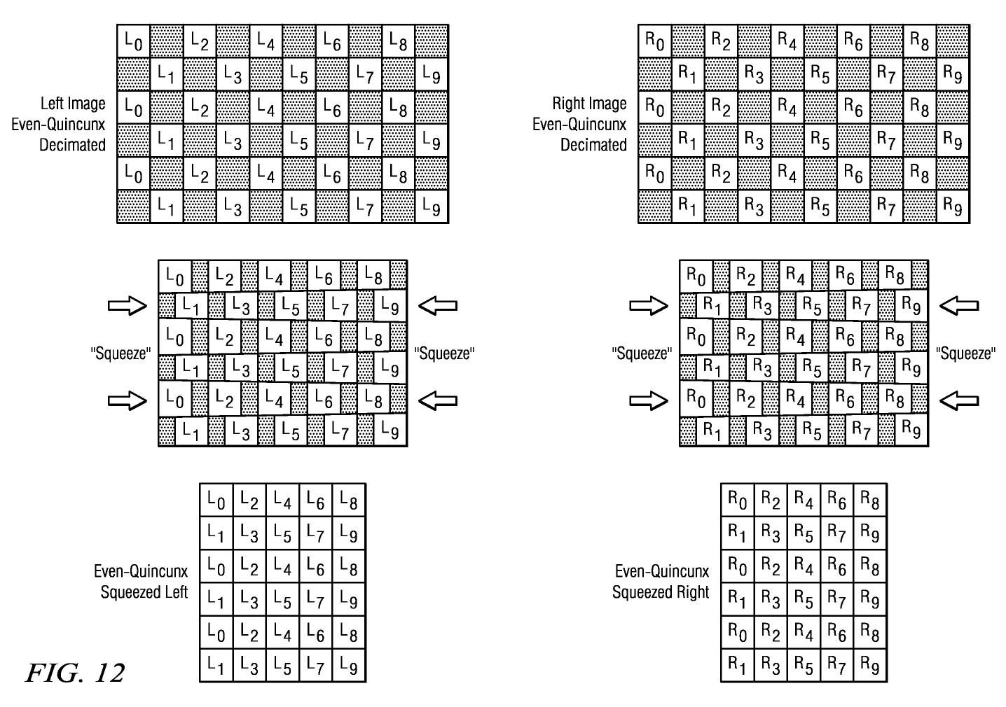

In an embodiment, the left and right pictures of a stereo pair are carried side-by-side in a single video frame; quincunx sampling may be employed to preserve horizontal and vertical resolutions. For example, assume that 1920×1080 HD frames are being used. The raw left and right picture data is first filtered and quincunx sampled to produce new images with a resolution of 960×1080. The samples of each frame are then “squeezed” to create a rectangular sampling format and the left and right images are placed side-by-side in a single frame. FIG. 12 illustrates the process of horizontally squeezing quincunx sub-sampled images. After combining, the left picture of the stereo pair will occupy the left half of the frame and the right picture will occupy the right half of the frame.

The resulting frame has both spatial and temporal correlations for easier compression. In fact, the stream may be compressed using a standard MPEG-2, H.264, or VC1 video encoder. Because of the quincunx sampling the vertical and horizontal correlations between pixels are slightly different than would be present for traditional rectangular sampling. Standard tools for interlaced video that are included in MPEG and VC1 systems can be used to efficiently handle the differences caused by quincunx sampling. In an embodiment, encoding the side-by-side stereo pair may be done at approximately the same bit rate as would be used to code a full-resolution 2D video stream.

A side-by-side video stream may be carried on all existing MPEG-TS based systems with no appreciable increase in the bandwidth used. It would be useful, however, to define a new stream type for use in the PSI to indicate to decoders that a compressed stream carries stereo TV information instead of 2D TV.

### Base Layer/Enhancement Layer Streams

In an embodiment, a side-by-side 3D video “base layer” is coded. For most applications, this base layer would provide acceptable 3D quality. When full resolution is used, an additional enhancement layer may be added to the base layer as a separately coded stream. When appropriately combined with the base layer, full resolution left and right pictures are obtained. Multiple approaches are possible for creating base-layer/enhancement-layer streams for side-by-side pictures.

There are many possible ways to carry enhancement streams within the MPEG standards. One approach is to insert the data in a separate Transport Packet PID Stream. Recall that the Program Map Table tells the decoder how many streams are in each program, what the stream types are, and on which PIDs they can be found. One approach to adding an enhancement stream is to add a separate PID stream to the multiplex and indicate via the PMT that this PID stream is part of the appropriate program. In the PSI tables, an 8-bit code may be used to indicate the stream type. The values 0x0F-0x7F are “reserved” meaning that the standard body could choose to allocate one of these for enhancement information of a particular type. Another possibility is to use one of the “user private” data types 0x80-0xFF and use the weight of industry adoption to establish a particular user private data type code as a de-facto standard. To be compatible with the ATSC specification, a value greater than 0xC4 should be chosen since the ATSC standard only allows these values for private program elements (see ATSC Digital Television Standard A/53, Part 3, Section 6.6.2).

Both MPEG-2 and H.264 have standardized provisions for carrying Stereo TV. The original MPEG-2 standard provides support for both temporal and spatial scalability. The idea behind temporal scalability is to code the video into two layers—a base layer and an enhancement layer. The base layer provides video frames at a reduced frame rate and the enhancement layer increases the frame rate by providing additional frames temporally situated between those of the base layer. The base layer is coded without reference to frames in the enhancement layer so it can be decoded by a decoder that does not have the ability to decode the enhancement layer. The frames of the enhancement layer can be predicted from either frames in the base layer or frames in the enhancement layer itself.

The coded representation of the base layer frames and the enhancement layer frames are both contained in the same video ES. In other words, the layer multiplexing is built into the ES standard, and it may not be necessary to use a system level structure to combine the base and enhancement layer frames. However, this may impose a processing and bandwidth penalty on the decoders, since the enhancement layer would not be in a separate PID stream.

The H.264 standard provides explicit support for stereo coding as either alternating fields or alternating frames. To achieve this, an optional header (more precisely, a supplemental enhancement information or SEI message) may be inserted after the Picture Parameter Set to indicate to the decoder that the coded sequence is a stereo sequence, see the H.264 Standard, Section D.2.22. An SEI message may further indicate whether or not field or frame interleaving of the stereo information has been employed and whether a given frame is a left-eye or right-eye view. H.264 supports a rich set of motion compensated prediction techniques so adaptive prediction of a given frame from either a left or right frame is supported. However, as in MPEG-2, this may impose a processing and bandwidth penalty on all decoders, since the enhancement layer is not in a separate PID stream.

MPEG-2 and MPEG-4 stereo and multi-view support typically bias quality towards one of the two video streams (generally the left eye view is higher quality).

In an embodiment, the base and enhancement layers are coded as two separate ESs, each with its own PID. There are cost and efficiency advantages to coding the base and enhancement layers as two ESs and multiplexing them together at the transport layer. Using existing transport packet devices, such as multiplexers and de-multiplexers to deal with such streams, is possible. For example, suppose a stereo signal with both base and enhancement layers is distributed via satellite to cable systems throughout the U.S. For distributors whose systems do not prefer full resolution, the enhancement layer may be easily dropped at the head-end by discarding packets with the PID that carries it. Systems with a want for and with adequate bandwidth to support the enhancement layer would pass through the entire multiplexed signal. The existing transport stream manipulation infrastructure may be used to add and subtract the enhancement layer on demand. This minimizes the want for service providers to acquire new devices and tools.

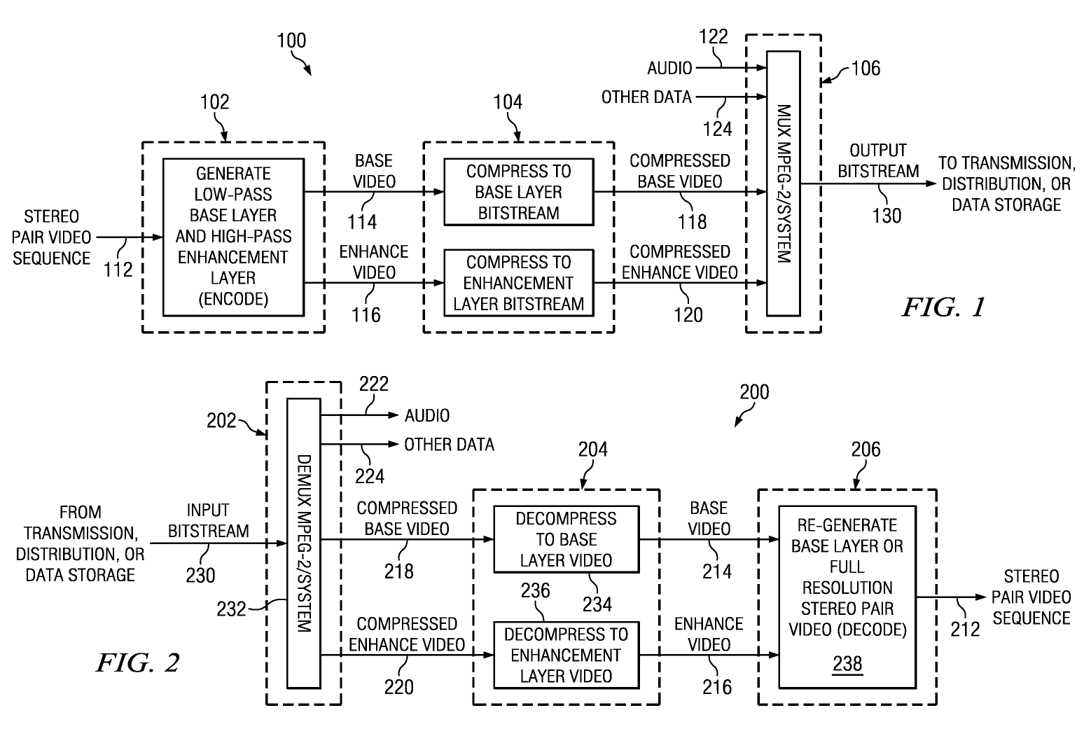

FIG. 1 is a schematic block diagram of an apparatus 100 for encoding stereoscopic video. In this embodiment, apparatus 100 includes an encoder module 102, a compressor module 104, and a multiplexer module 106, arranged as shown.

In operation, encoder module 102 may receive a stereoscopic video sequence 112. The stereoscopic video sequence 112 at the input may be two video sequences—a left eye sequence and a right eye sequence. The two video sequences may be reduced to a single video sequence with a left-eye image in the left half of the picture and a right-eye image in the right half of the picture. The encoder module 102 is operable to generate stereoscopic base layer video 114 and the stereoscopic enhancement layer video 116 from the stereoscopic video sequence. The stereoscopic enhancement layer video 116 contains the residual left and right image data that is not in the stereoscopic base layer video 114. The stereoscopic base layer video includes a low-pass base layer, and the stereoscopic enhancement layer video 116 includes a high-pass enhancement layer.

At compressor module 104, the stereoscopic base layer video 114 may be compressed to compressed base layer video 118, and the stereoscopic enhancement layer video 116 compressed to compressed enhancement layer video 120. Multiplexer module 106 may generate an output bitstream 130 by multiplexing compressed base layer video 118, compressed enhancement layer video 120, audio data 122, and other data 124. Other data 124 may include left and right image depth information, for use in the decoding process to assist with creating additional views or improving image quality, 3D subtitles, menu instructions, and other 3D-related data content and functionalities. Output stereoscopic bitstream 130 may then be stored, distributed and/or transmitted.

A combined enhancement layer, containing both scalable stereoscopic image information and depth, is a backward compatible embodiment of the more general distribution of multi-faceted texture and form which may be used by future 3D visualization platforms.

An algorithm may be used in which the enhancement (residual) sequences is created at approximately the same time as the base layer side-by-side sequence. Furthermore, the residual sequences may also be combined into a single side-by-side video sequence with substantially no loss of information. An approach satisfying this constraint is said to be critically sampled. This means that the process of creating the side-by-side base layer stereo pair and the residual sequences leads to substantially no increase in the number of samples (i.e. pixels or real numbers) used to represent the original sequence. Like a Discrete Fourier Transform (DFT), N samples go in and N samples in a different form come out.

Two side-by-side stereo pair images will ultimately be generated by this process, one that is low-pass in nature and one that is high-pass in nature, both of these side-by-side images will have the same resolution as the original two input images. In the absence of compression artifacts, the images can be recombined to substantially perfectly regenerate the original two input images from the stereo pair.

The base and enhancement layers may be compressed independently of each other, even though they may no longer alias cancel after synthesis once compression errors are introduced. When compression artifacts are present, it is preferred that the alias canceling property still works.

FIG. 2 is a schematic block diagram of an apparatus 200 for decoding a stereoscopic video bitstream 230 (e.g., the output stereoscopic bitstream 130 of FIG. 1). In this embodiment, apparatus 200 includes an extraction module 202, decompressor module 204, and combining module 206, arranged as shown.

In operation, stereoscopic video bitstream 230 may be received from transmission, distribution, or data storage (e.g., cable, satellite, blu-ray disc, etc.). In some embodiments, the stereoscopic video bitstream 230 may be received via a buffer (not shown), the implementation of which should be apparent to a person of ordinary skill in the art.

Extraction module 202 may be a demultiplexer, and may be operable to receive the input bitstream 230 and extract from the input bitstream 230 compressed stereoscopic base layer video 218 and compressed stereoscopic enhancement layer video 220. The extraction module 202 may be further operable to extract audio data 222 from the input bitstream, as well as other data 224, such as depth information, etc. The extraction module may be further operable to extract a content information tag from the input bitstream 230; or alternatively, a content information tag may be extracted from the stereoscopic base layer video 214.

Decompressor module 204 may include first decompressing module 234 operable to decompress the compressed stereoscopic base layer video 218 into stereoscopic base layer video 214. Decompressor module 204 may also include a second decompressing module 236 operable to decompress the compressed stereoscopic enhancement layer video signal 220 into stereoscopic enhancement layer video 216.

Combining module 206 may be operable in a first mode to generate a stereo pair video sequence 212 from the stereoscopic base layer video 214 and not the stereoscopic enhancement layer video 216. In a second mode, combining module 206 may be operable to generate a stereo pair video sequence 212 from both the stereoscopic base layer video 214 and the stereoscopic enhancement layer video 216. Combining module 206 may, in some embodiments, add a content information tag, such as that disclosed in application Ser. No. 12/534,126, entitled “Method and apparatus to encode and decode stereoscopic video data,” filed Aug. 1, 2009, herein incorporated by reference.

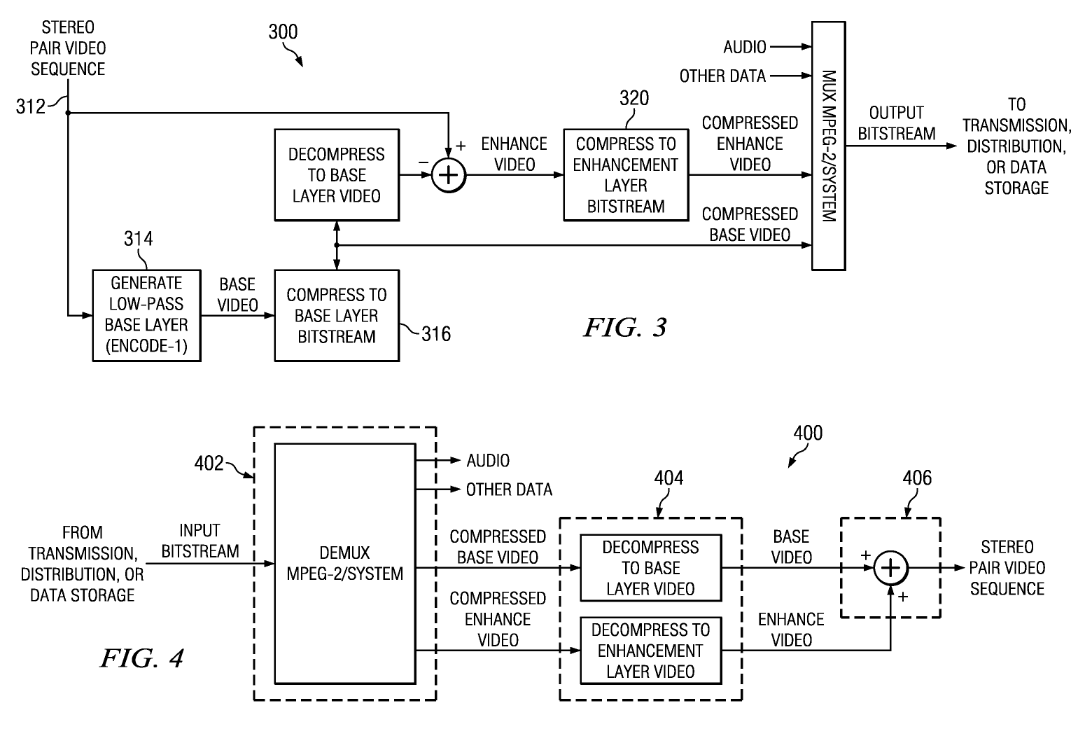

FIG. 3 is a schematic block diagram of an apparatus 300 for encoding stereoscopic video. In this embodiment, apparatus 300 may include a closed-loop encoder 314, compressor 316, and multiplexer 318, arranged as shown.

FIG. 4 is a schematic block diagram of an apparatus 400 for decoding stereoscopic video. In this embodiment, apparatus 400 may include an extraction module 402, a decompressor module 404, and a combining module 406, arranged as shown.

As shown in FIGS. 3 and 4, correction for Base Layer compression artifacts may be implemented by closing an error loop around the Base Encoder 314 and Base Compressor 316. The difference between the encoded, compressed Base signal and the full resolution source is used as the input to the Enhancement layer compressor 320. In an embodiment, this results in the Enhancement layer data size increasing by a factor of two relative to the previously-described open loop embodiment, described with reference to FIG. 1.

A decoder that only has access to the base layer bit stream can decode a high-quality stereo TV signal, while decoders with access to the base layer and the enhancement layer bit streams can decode a full resolution stereo TV signal.

Additional enhancement layer information could also include left and right image depth information, encoded as video data, for use in the decoding process to assist with creating additional views or improving image quality. Similar video compression techniques could be used to compress this additional image information.

FIG. 5A shows a cardinal sampling grid 502 and FIG. 5B shows its associated spatial frequency response 504. As shown in FIG. 5B, cardinal sampling is not isotropic. It has greater diagonal resolution than vertical or horizontal resolution, by a factor of \sqrt{2}, or about 1.41.

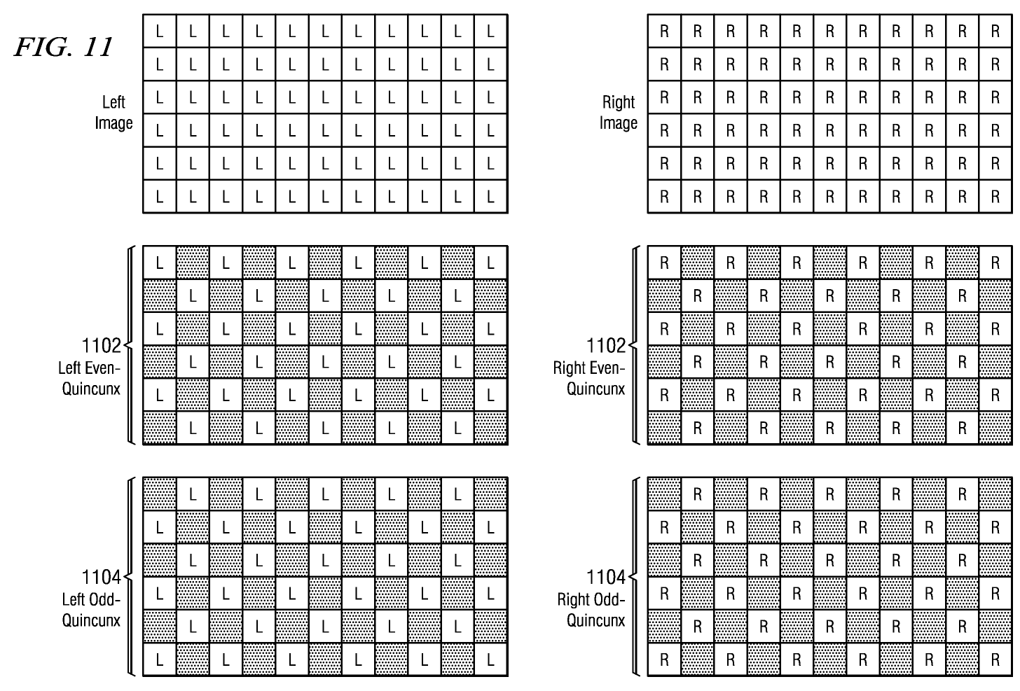

FIG. 11 is a schematic diagram showing a definition of odd and even quincunx sampling patterns. As shown in FIG. 11, a cardinally sampled image can be divided into even quincunx (or checkerboard) pixels 1102 and odd quincunx pixels 1104. If the pixels are numbered from zero in both the vertical and horizontal directions, the even quincunx pixels 1102 are those where the sum of their X and Y coordinates is an even number. Similarly, the odd quincunx pixels 1104 are those where the sum of their X and Y coordinates is an odd number. For example, the upper left pixel in a cardinally sampled image has X=0 and Y=0 and is an even quincunx pixel.

FIG. 8 shows an approximation of the human visual system frequency response 800. As shown by frequency response 800, the human visual system (HVS) is not isotropic. It is more sensitive to details in the cardinal directions (horizontal and vertical) than it is in the diagonal directions. This is known as the oblique effect. While this effect varies with viewing conditions and image contrast, the effect causes the HVS diagonal resolution to be less than about 80% of the cardinal directions. When combined with the anisotropy of cardinal sampling, diagonal information is over-sampled by about a factor of two.

Quincunx sampling has a diamond-shaped spectrum that closely matches the spatial frequency response of the HVS, as can be seen by comparing FIGS. 7B and 8. Quincunx sampling uses one-half as many samples as cardinal sampling to represent the image, but the vertical and horizontal resolution is unchanged. The slight loss of diagonal resolution has an extremely small effect on the perceived resolution.

A cardinally sampled image can be converted to quincunx sampling using a filter with a diamond-shaped passband, followed by discarding the extra samples (in a checkerboard fashion). The resulting image will have half as many pixels, but full horizontal and vertical resolution.

When discarding the extra pixels, one may either discard the odd or the even checkerboard pixels. It may be desirable to discard odd pixels for one eye and even pixels for the other eye. This may preserve the full diagonal resolution of text and other objects in the 3D stereo scene that are at the Z=0 plane. In addition, any alias components in the left and right images may be out-of-phase and may cancel. This mode is also well matched to DLP-based displays that inherently use a quincunx display device.

Another alternative is for the left and right images to use the same checkerboard phase, for simplicity and consistency.

For multiplexed stereo 3D applications, two quincunx-sampled images can be fit into the space of one cardinally sampled image. This allows the use of standard 2D equipment, from production through distribution, broadcast, and reception. The two images can be packed side-by-side, top-and-bottom, as an interleaved checkerboard, or any other pattern desired, as long as the total pixel count is not changed in the packing process. The left and right images can be of differing resolutions, and the resolution can vary with the position in the frame. In an embodiment, the packing is side-by-side and the memory used to convert between packed and unpacked formats is minimized. The side-by-side packing will be used in the following, but it is to be understood that the embodiments herein described are merely illustrative of the application of the principles of this disclosure and other packing techniques such as top/bottom, quincunx, etc. may be used. Reference herein to details of the illustrated embodiments is not intended to limit the scope of the claims, which themselves recite those features regarded as essential to this disclosure.

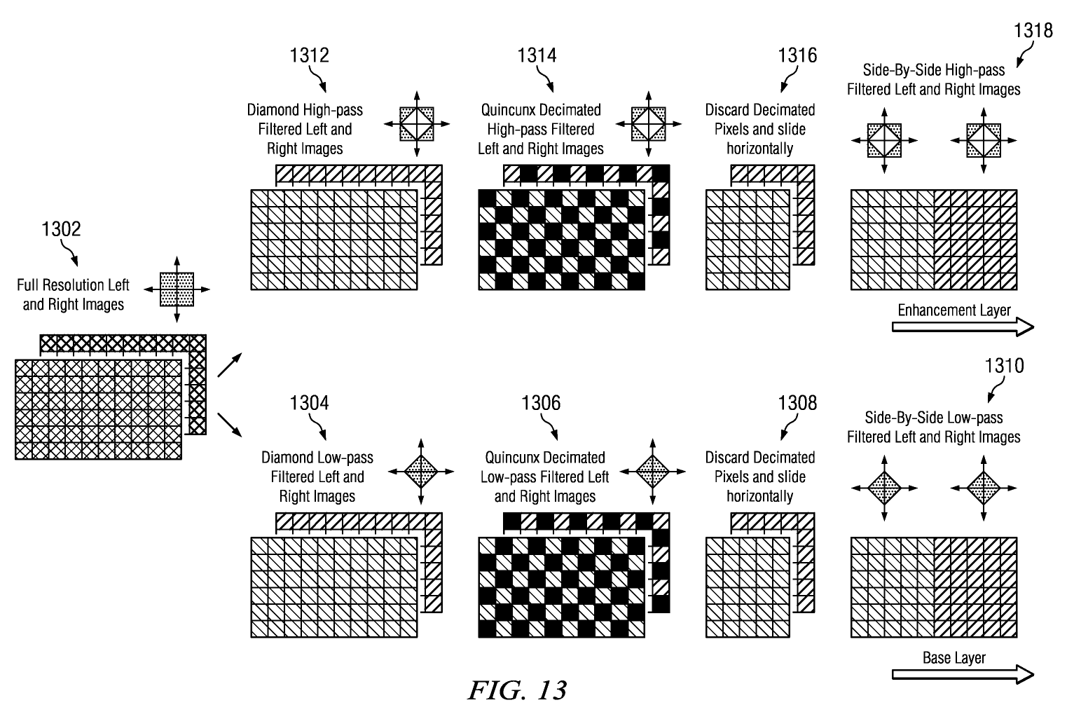

FIG. 13 is a schematic diagram illustrating a stereoscopic image processing encoding technique using quincunx-sub-sampled base and enhancement layers and 2D diamond convolution filters. The technique begins by receiving full resolution left and right images at 1302.

In creating the base layer, the full resolution left and right images are low-pass filtered at 1304, then they are quincunx decimated at 1306. The pixels that are decimated from the quincunx filtering of step 1306 are then discarded and slid horizontally at step 1308. The resultant quincunx left and right images may then be added together to provide a side-by-side low-pass filtered left and right image frame, at 1310.

In creating the enhancement layer, the full resolution left and right images are high-pass filtered at 1312, then they are quincunx decimated at 1314. The pixels that are decimated from the quincunx filtering of step 1314 are then discarded and slid horizontally at step 1316. The resultant quincunx left and right images may then be added together to provide a side-by-side high-pass filtered left and right image frame, at 1318.

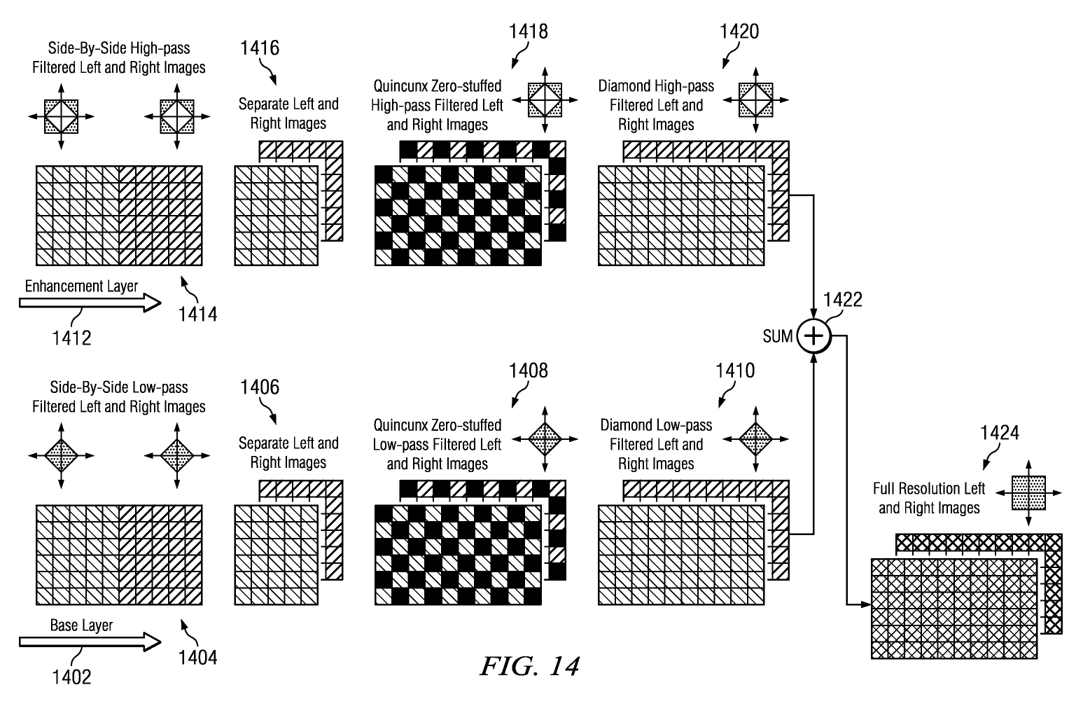

FIG. 14 is a schematic diagram illustrating a stereoscopic image processing decoding technique for a decoder using quincunx-sub-sampled base and enhancement layers and 2D diamond convolution filters.

In operation, left and right images from base layer 1402 are extracted via side-by-side low-pass filtering at step 1404. Left and right images are separated at 1406, then they are zero-stuffed in accordance with a quincunx scheme at step 1408. The quincunx zero-stuffed low-pass filtered left and right images are then diamond low-pass filtered at step 1410. Similarly, left and right images from enhancement layer 1412 are extracted via side-by-side high-pass filtering at step 1414. Left and right images are separated at 1416, then they are zero-stuffed in accordance with a quincunx scheme at step 1418. The quincunx zero-stuffed high-pass filtered left and right images are then diamond high-pass filtered at step 1420. The low- and high-pass diamond filtered stereoscopic images are then summed together at step 1422 to create full resolution left and right images at step 1424.

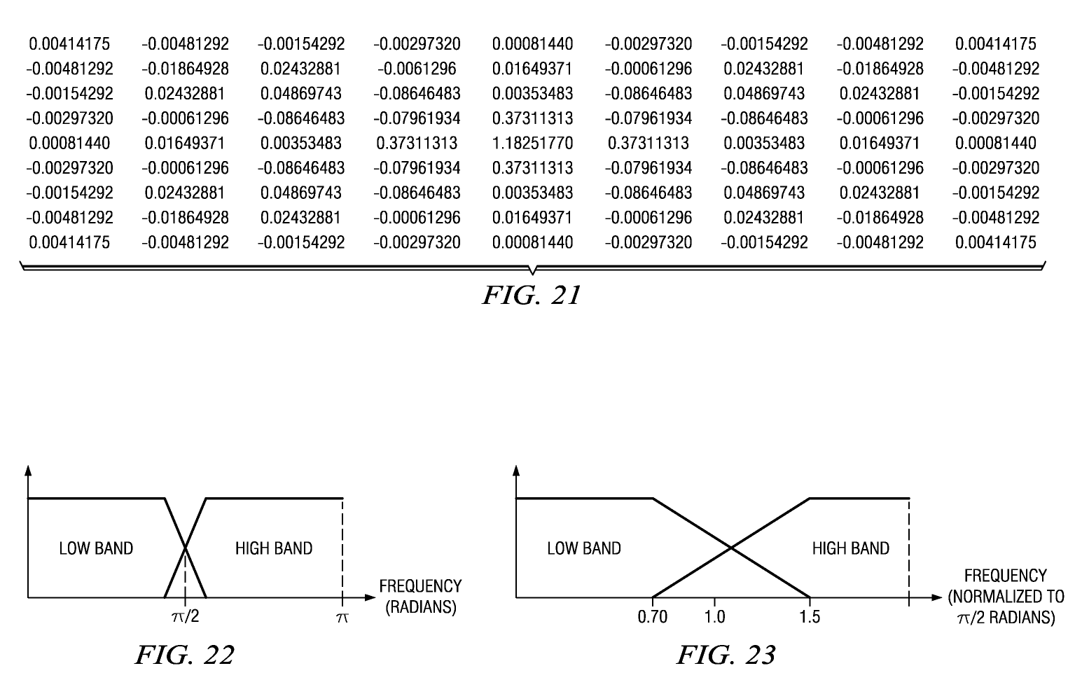

As shown in FIGS. 13 and 14, an embodiment uses 2D filters with diamond-shaped low-pass and high-pass characteristics. The low-pass and high-pass filters can be implemented by any suitable technique. For example, a programmable filter kernel array can be used to obtain the desired filter characteristics. FIG. 21 is a table illustrating an example of a 9×9 filter kernel coefficients which may be used to implement a 2D diamond low-pass filter array. The 2D diamond high-pass filter can be independently designed, or generated from the 2D diamond low-pass filter, using techniques such as Quadrature Mirror Filter techniques or Conjugate Mirror Filter techniques. Such techniques are disclosed by Vaidyanathan in “Multirate Systems and Filter Banks,” PTR Prentice-Hall (1993); by Vetterli and Kovacevic in “Wavelets and Subband Coding,” PTR Prentice-Hall (1995); and by Akansu and Haddad in “Multiresolution Signal Decomposition: Transforms-Subbands-Wavelets,” Academic Press (1992), herein incorporated by reference.

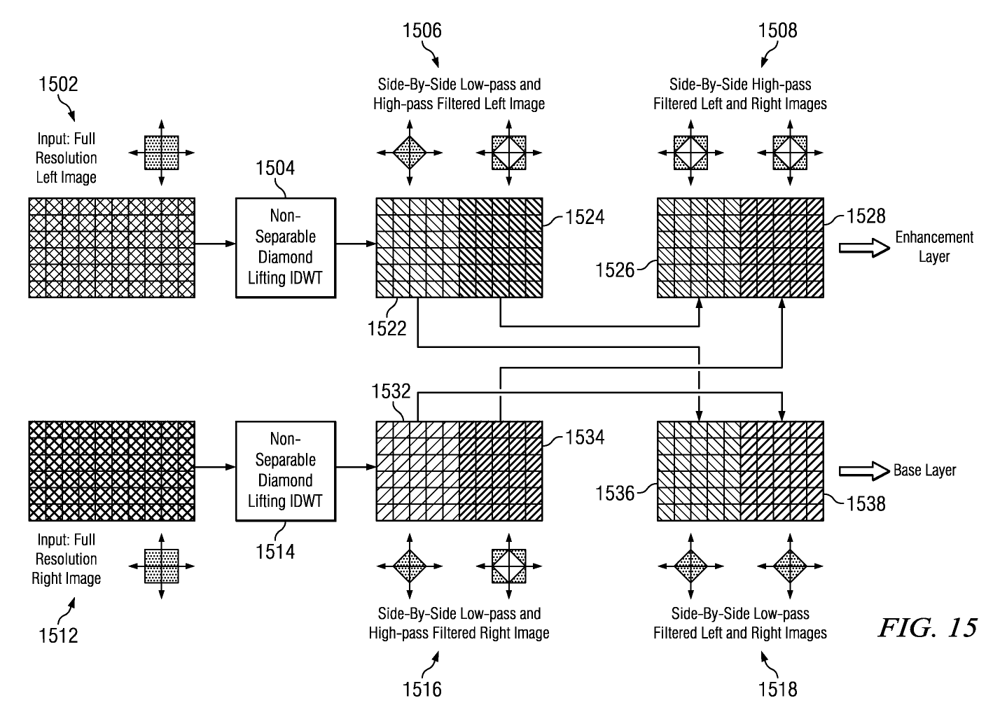

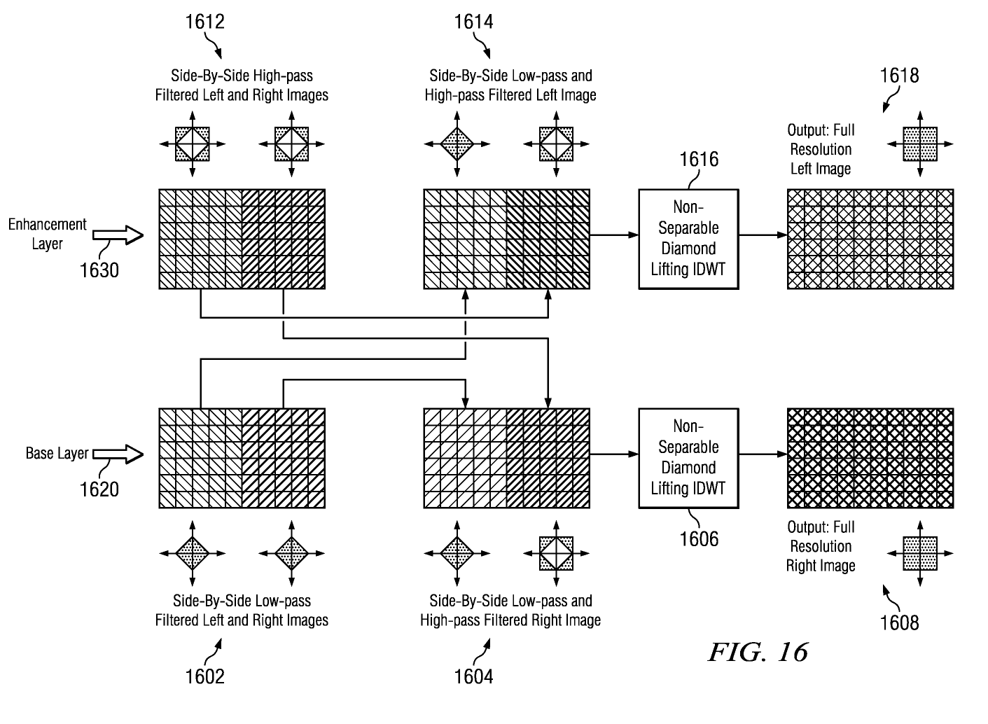

FIGS. 15 and 16 illustrate another embodiment of an encoder/decoder pair, using a non-separable 2D Lifting Discrete Wavelet Transform filter. Another embodiment uses the well-known Cohen-Daubechies-Feauveau (9, 7) biorthogonal spline filter, used in a 2D non-separable quincunx 4-step lifting form. FIG. 21 shows the lifting structure and coefficients for each lifting step.

In accordance with the coding process of FIG. 15, in operation, a full resolution left image is received at 1502. A non-separable diamond lifting inverse discrete wavelet transform is performed on the full resolution left image at 1504, and then a side-by-side low-pass and high-pass filtering process is performed at 1506. Similarly, a full resolution right image is received at 1512. A non-separable diamond lifting inverse discrete wavelet transform (IDWT) is also performed on the full resolution right image at 1514, and then a side-by-side low-pass and high-pass filtering process is performed at 1516. As shown in FIG. 15, left side image 1522 may be combined with left side image 1532 in a side-by-side arrangement, with image 1522 occupying the left side of the frame 1536 and image 1532 occupying the right side of the frame 1538 (step 1518). Similarly, right side image 1524 may be combined with right side image 1534 in a side-by-side arrangement, with image 1524 occupying the left side of the frame 1526 and image 1534 occupying the right side of the frame 1528 (step 1508). Accordingly, frame 1536/1538 provides the base layer, while frame 1526/1528 provides the enhancement layer.

Decoding of the base and enhancement layers may be performed according to the sequence illustrated in FIG. 16. Here, the base layer 1620 and the enhanced layer 1630, respectively made up of side-by-side low-pass and high-pass filtered left and right images 1602, 1612 are respectively converted into side-by-side low-pass and high-pass filtered right images 1604, 1614. Non-separable diamond lifting IDWTs are performed at steps 1606, 1616, resulting in output full resolution right image 1608 and full resolution left image 1618.

Lifting is a preferred implementation in JPEG2000, but is typically used in a separable rectangular two-pass approach as disclosed by Acharya and Tsai in “JPEG200 Standard for Image Compression,” Wiley Interscience (2005), herein incorporated by reference.

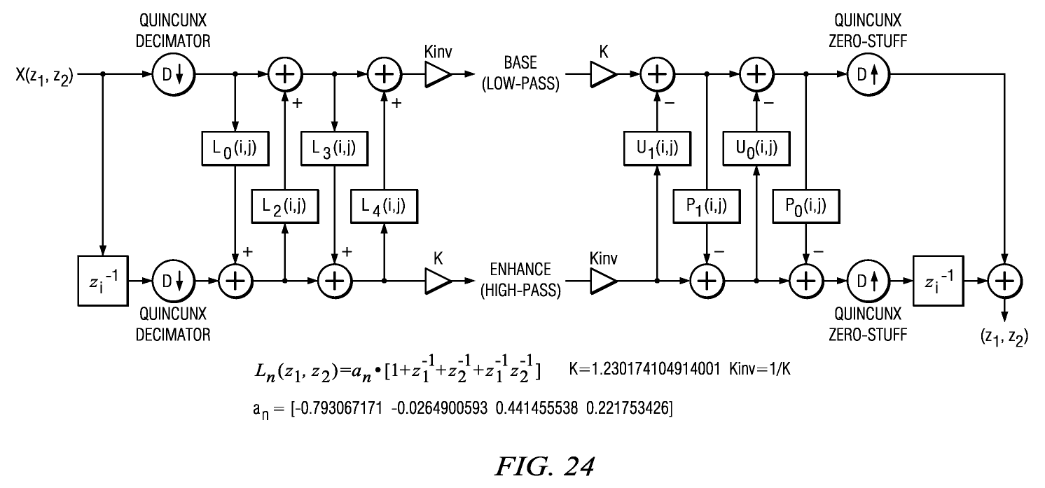

Quadrature Mirror Filters (QMF), Conjugate Mirror Filters (CMF), and Lifting Discrete Wavelet Transform filters are perfect-reconstruction (PR) filters. Perfect-reconstruction filters can give outputs that are identical to the inputs, without using extra bandwidth. This is called critical sampling, or maximally decimated filtering. Since the frequency cutoff of practical filters cannot be infinitely sharp, the pass-bands of the low-pass and high-pass filters should overlap if all the signal information is to be transferred. FIG. 24 shows a 1D example. Each sub-band should include aliased signals from the adjacent sub-band(s). While each of the sub-bands will have aliasing on its own, when recombined, the aliases cancel, and the output will be identical to the input. This is the definition of a perfect-reconstruction filter bank and will be well known to one skilled in the art of signal processing. Note that if any of the sub-bands are distorted by other elements in the system (e.g. by compression artifacts) the output is no longer identical to the input and the alias canceling may fail, possibly causing artifacts in other sub-bands.

Lifting (Sweldens) implementations of wavelets make substantially perfect-reconstruction filters. Biorthogonal 2-band filter banks use four filter coefficient sets: analysis low-pass, analysis high-pass, synthesis low-pass, and synthesis high-pass. Orthogonal 2-band filter banks use two filter coefficient sets (i.e. low-pass and high-pass), with the same coefficients for analysis and synthesis. Another embodiment uses a 1D filter bank, either in perfect-reconstruction form or not. Any of these filters are appropriate for generating the Base and Enhancement layers, and for recombining the Base and Enhancement layers.

An embodiment of this uses a non-separable 2D lifting wavelet filter with a diamond-shaped passband. Another embodiment uses 2D Diamond convolution filters, which can be perfect-reconstruction filters, or not, depending on design.

A stereo pair of two cardinally sampled source images may be converted to a pair of side-by-side images, using 2D convolution filters. The first of the pair of side-by-side images, called Base, contains the low-pass filtered left and right images. The second of the pair of side-by-side images, called Enhancement, contains the high-pass filtered left and right images. As shown in FIG. 13, to generate the Base, each of the cardinally sampled images are 2D diamond low-pass filtered, followed by quincunx decimation. This reduces the number of pixels in each image by a factor of two, i.e. critically sampled. In this example, the two reduced images are packed side-by-side in the Base image, which has the same dimensions as either of the source images. Enhancement is generated in a similar way, except that a high-pass filter is used.

In another embodiment, a stereo pair of two cardinally sampled source images can be converted to a pair of side-by-side images, using a 2D Lifting Discrete Wavelet Transform filter. A feature of the Lifting Discrete Wavelet Transform is that the low-pass and high-pass decimated images are generated in-place, without the need for a separate decimation step. This reduces the numerical calculations significantly, but the resulting images may be rearranged as shown in FIG. 15, such that the two high-pass filtered images become Enhancement and the two low-pass images become Base.

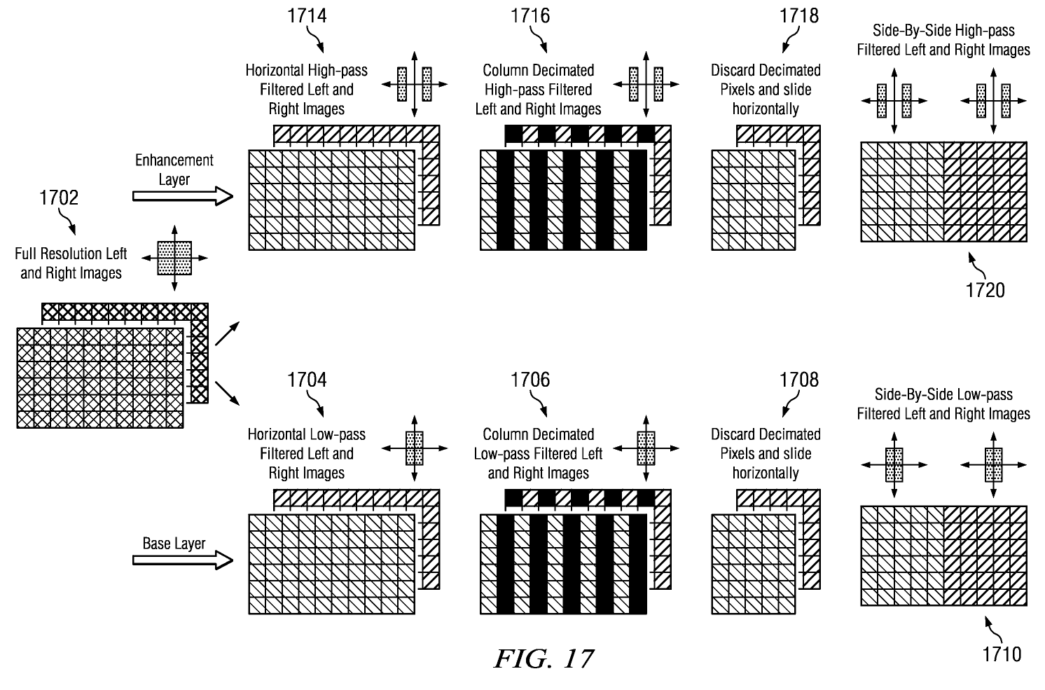

In another embodiment, a stereo pair of two cardinally sampled source images may be converted to a pair of side-by-side images, using 1D horizontal convolution filters. The first of the pair of side-by-side images, called Base, contains the low-pass filtered left and right images. The second of the pair of side-by-side images, called Enhancement, contains the high-pass filtered left and right images. FIG. 17 is a schematic diagram of an encoder using column-sub-sampled base and enhancement layers and 1D horizontal convolution filters. Full resolution left and right images are received at 1702. As shown in FIG. 17, to generate the Base, each of the cardinally sampled images are 1D horizontally low-pass filtered at 1704, followed by column decimation at 1706. Decimated pixels are discarded and slid horizontally at 1708. This may reduce the number of pixels in each image by a factor of two, i.e. critically sampled. In this example, the two reduced images are packed side-by-side in the Base image, at 1710, which has the same dimensions as either of the source images. Enhancement is generated in a similar way, in steps 1714, 1716, 1718, 1720, except that a high-pass filter is used.

In another embodiment, a stereo pair of two cardinally sampled source images may be converted to a pair of top-and-bottom images, using 1D vertical convolution filters. The first of the pair of top-and-bottom images, called Base, contains the low-pass filtered left and right images. The second of the pair of top-and-bottom of images, called Enhancement, contains the high-pass filtered left and right images.

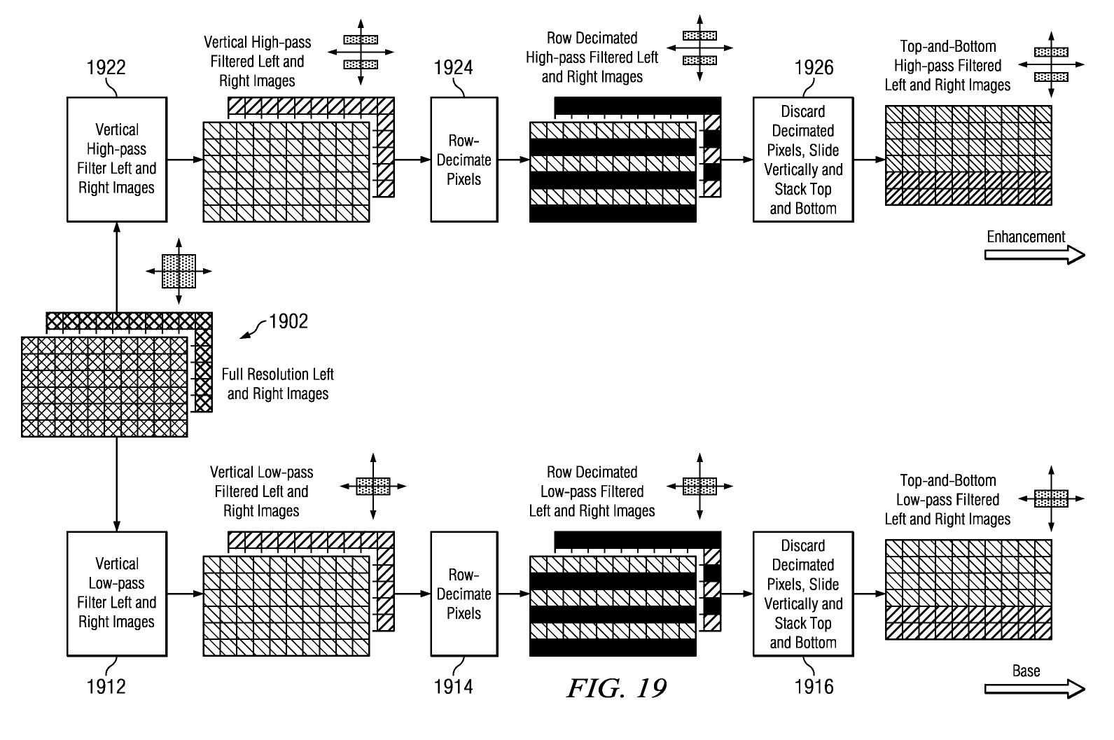

FIG. 19 is a block diagram of an encoder using column-sub-sampled base and enhancement layers and 1D vertical convolution filters. Full resolution left and right images are received at 1902. As shown in FIG. 19, to generate the Base, each of the cardinally sampled images are 1D vertical low-pass filtered at 1912, followed by row decimation at 1914. This may reduce the number of pixels in each image by a factor of two, i.e. critically sampled. In this example, the two reduced images are packed top-and-bottom in the Base image at 1916, which has the same dimensions as either of the source images. Enhancement is generated in a similar way, in steps 1922, 1924, 1926, except that a high-pass filter is used.

Regardless of the specific embodiment used to create the Base and Enhancement images, they may be independently compressed, recorded, transmitted, distributed, received, and displayed, using conventional 2D equipment and infrastructure.

An embodiment uses only the Base layer, while discarding the Enhancement layer. In another embodiment, both the Base and Enhancement layers are used, but the Enhancement layer data is null or effectively null and can be ignored. When using only the Base layer for display, the decoded Base layer images may be used as-is, or they may be converted to different sampling geometries as used by the particular display technology being used. If the Base layer was generated using 2D diamond filtering, this provides diamond-shaped resolution, with full diamond resolution horizontally and vertically, but with reduced diagonal resolution, as compared to the original cardinally sampled images. If the Base layer was generated using 1D filtering, the horizontal or vertical resolution will be approximately half the original cardinally sampled images.

In an embodiment, the full cardinal resolution of the source images can be recovered by recombining the Base and Enhancement images using suitable filters. As shown in FIGS. 14 and 16, to reconstruct cardinally sampled left and right images from the Base, the left and right images contained in the Base are quincunx zero-stuffed, followed by diamond low-pass filtering, using convolution filtering, 2D wavelet filtering, or any other suitable 2D filter. This may increase the number of pixels in each image by a factor of two, each matching the original source image size. The resulting cardinally sampled left and right images will still have a diamond-shaped spatial resolution, as shown in FIG. 7B.

Enhancement is reconstructed in a similar way, except that a high-pass filter is used. By adding the reconstructed Base and Enhancement images, the resulting left and right images have full resolution, as shown in FIG. 5.

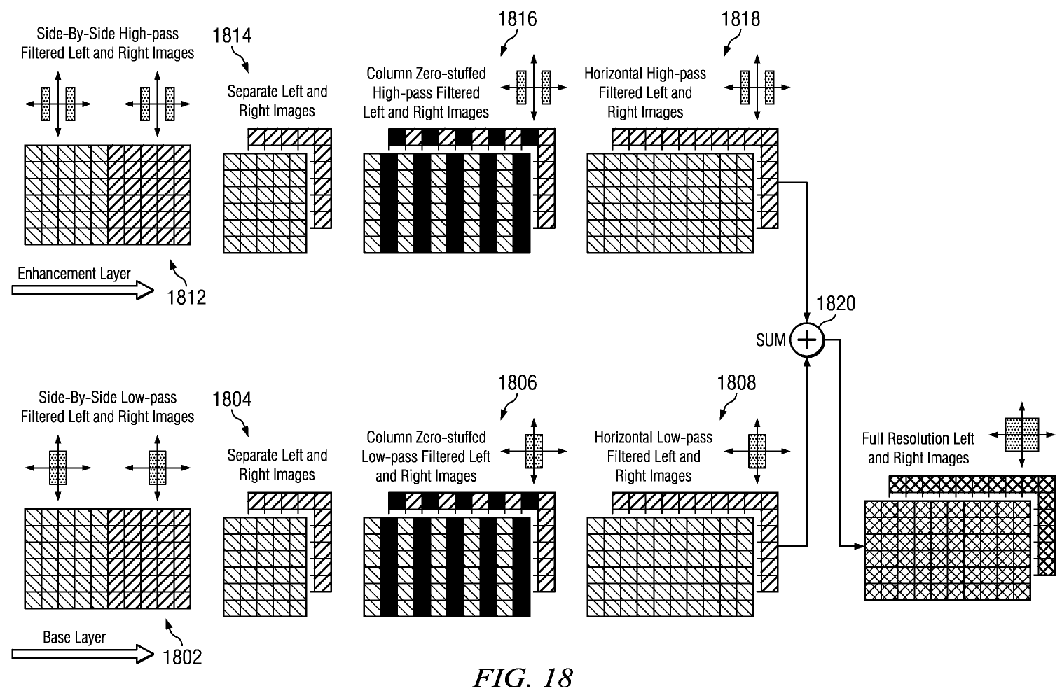

If the Base and Enhancement layers were generated using 1D horizontal filtering, as shown in FIG. 17, the full resolution can still be recovered. FIG. 18 is a schematic block diagram of a decoder using column sub-sampled base and enhancement layers and 1D horizontal convolution filters. The full resolution may be recovered in a similar manner by the diamond 2D embodiment, as shown in FIG. 18. The left and right images in the respective Base and Enhancement layers 1802, 1812 are separated at 1804, 1814. Then they are column zero-stuffed at 1806, 1816, followed by low-pass and high-pass filtering at 1808, 1818, respectively. By adding the reconstructed Base and Enhancement images at 1820, the resulting left and right images have full resolution, as shown in FIG. 5.

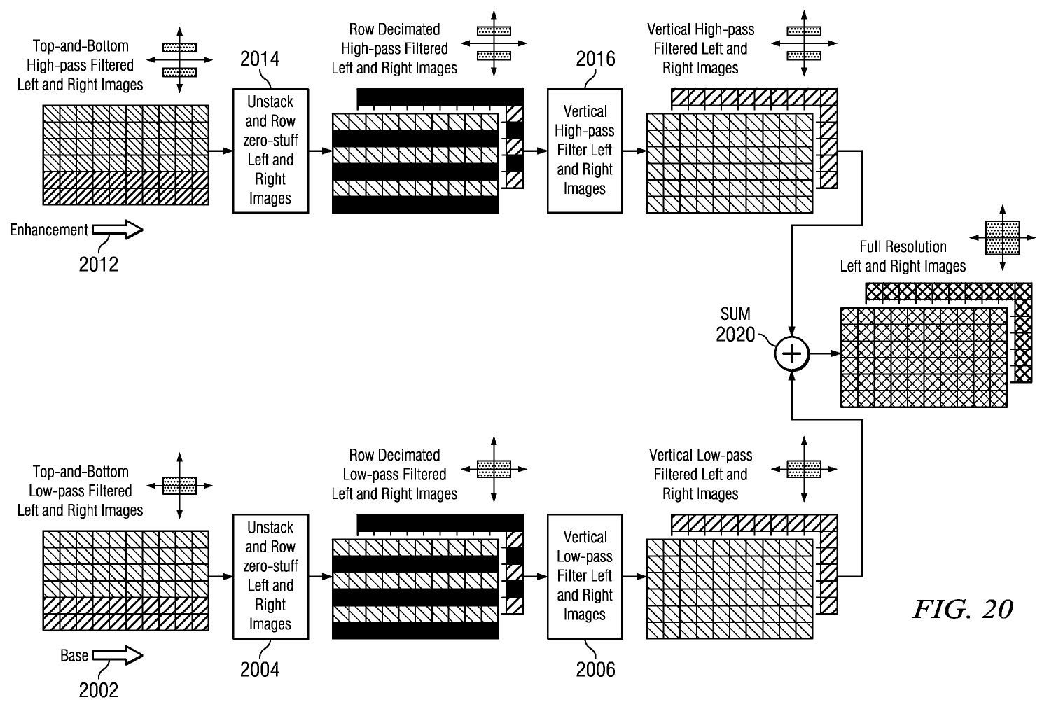

FIG. 19 is a block diagram of an embodiment of an encoder using column-sub-sampled base and enhancement layers and 1D vertical convolution filters. If the Base and Enhancement layers were generated using 1D vertical filtering, as shown in FIG. 19, the full resolution may be recovered, in a similar manner to the diamond 2D embodiment, as shown in FIG. 20.

FIG. 20 is a schematic diagram illustrating a stereoscopic image processing decoding technique using column sub-sampled base and enhancement layers and 1D vertical convolution filters. In operation, the Base and Enhancement layers 2002, 2012 are unstacked and row zero-stuffed at 2004, 2014, followed by low-pass and high-pass filtering, at 2006, 2016, respectively. By adding the reconstructed Base and Enhancement images at 2020, the resulting left and right images have full resolution, as shown in FIG. 5.

FIG. 22 shows a 1D example of a 2 band perfect reconstruction filter's frequency response. In any of the embodiments, for compatibility with current practice and infrastructure, or for reduced bandwidth parameters, it may be preferred to reconstruct the output left and right images from the Base, or low-pass filtered, images alone. It may also be desirable to generate only the Base layer images and thus not distribute the Enhancement layer.

FIG. 23 shows a 1D example of a 2 band perfect reconstruction filter's frequency response, modified for improved image quality. The characteristics of the synthesis filters (complementary low-pass and high-pass) can be optimized for improved image quality in the case that the Base layer is used without the Enhancement layer. This may also result in modifications to the matching analysis filters. In an embodiment, approximately one octave (e.g. a factor of two) of aliasing is intentionally introduced into the synthesis low-pass filter. This is accomplished by setting the cutoff frequencies of the high-pass and low pass filters to be approximately 0.7 and 1.5 of the center of the full-resolution passband, as shown in FIG. 23. Such techniques have been discussed by Glenn in “Visual Perception Studies to Improve the Perceived Sharpness of Television Images,” Journal of Electronic Imaging 13(3), pp. 597-601 (July 2004) and “Digital Image Compression Based on Visual Perception,” in Digital Images and Human Vision, Andrew B. Watson, Ed., MIT Press, Cambridge (1993), herein incorporated by reference.

Compression and distribution systems are often used to use reduced bandwidth, resulting in image distortion. This may be due to storage or transmission limitations, or due to real-time network or system bandwidth needs or limitations. An advantage of using multiplexed stereo images, as opposed to MPEG-4/AVC/MVC/SVC or MPEG-2/MVC, is that the multiplexed images are always processed in a similar manner by the compression and distribution systems. This may result in left and right images of matching image quality. In contrast, MVC systems can cause distortion of the left and right images that is inconsistent, resulting in impaired image quality.

A disadvantage to non-multiplexed stereo in compression systems such as MPEG-2 and VC1 is that these systems only use two frames for predictive coding (one before and one after the frame being predicted). With frame-interleaved systems, (e.g. MVC), this means a left image can only be predicted from a right image, and conversely, a right image can only be predicted from a left image. The predictor cannot see next/last frame of same eye, resulting in poor compressions efficiency.

While MPEG-4/AVC/MVC/SVC may use multiple frames for prediction, it is an extension of standard MPEG-4/AVC and is not available in the current infrastructure. With multiplexed stereo images, MPEG-4/AVC does not need MVC or SVC to get good compression rates.

With multiplexed stereo images, every image contains both left and right information, which can be used for predictive coding, which may result in higher image quality for a given compressed data rate, or a lower compressed data rate for a given image quality.

If the compression system used, such as MPEG and VC1, has tools or features designed to improve performance on interlaced video, the tools and/or features may improve the compression efficiency when used with squeezed quincunx decimated multiplexed images, due to the effective half pixel offset per line inherent in the images.

At the decoder, MPEG or VC1 Pan/Scan information can be used to provide backwards compatibility for 2D display, by instructing the decoder to show only the left or right half of the side-by-side multiplexed stereo image. For preferred image quality, the decoder may use the same type of filtering as the stereo 3D decoder, but for simplicity and cost reasons, the decoder may use a simple horizontal resize to convert the selected half-width image to full size.

When using a DLP-based SmoothPicture® display, which has diamond shaped pixels, a simple horizontal resize may be used, as the diamond shape of the display pixel will optically filter the signal to remove diagonal aliasing. For improved image quality, or for displays that have non-diamond-shaped pixels, it may be preferred to use more sophisticated electronic filtering, such as the non-separable filters already described herein.

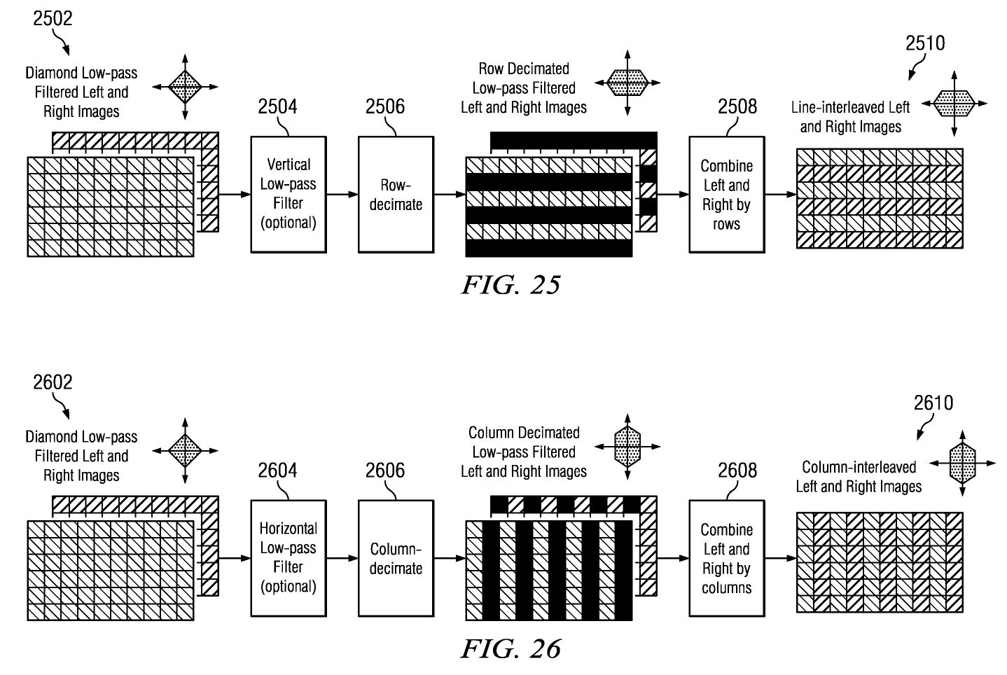

After the Base and Enhancement layers have been decoded and the full resolution cardinally sampled image has been reconstructed, it may be converted to any of several display-dependent formats, including DLP checkerboard, Line interleave, page flip (also known as frame interleave or field interleave), and column interleave, as shown in FIGS. 25-33.

FIG. 25 is a schematic diagram illustrating a stereoscopic image processing conversion technique from diamond low-pass filtered left and right images to line interleaved format. Here, diamond low-pass filtered left and right images 2502 are optionally vertically low-pass filtered at 2504, then row decimated at 2506. Alternating rows of left and right images may then be combined at 2508 to generate line-interleaved left and right images 2510.

FIG. 26 is a schematic diagram illustrating a stereoscopic image processing conversion technique from diamond low-pass filtered left and right images to column interleaved format. Here, diamond low-pass filtered left and right images 2602 are optionally horizontally low-pass filtered at 2604, then column decimated at 2606. Alternating columns of left and right images may then be combined at 2608 to generate column-interleaved left and right images 2610.

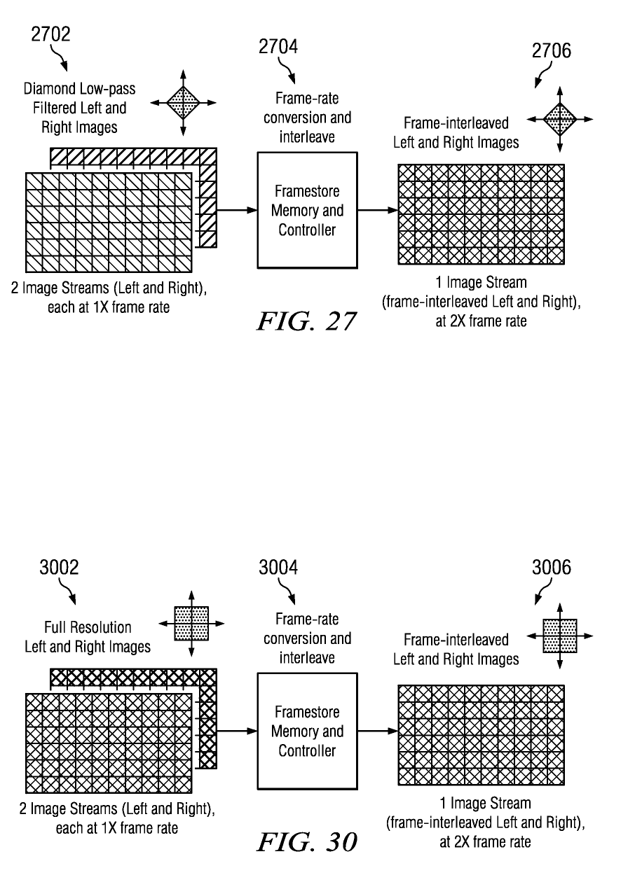

FIG. 27 is a schematic diagram illustrating a stereoscopic image processing conversion technique from diamond low-pass filtered left and right images to frame interleaved format. In this embodiment, diamond low-pass filtered left and right images 2702 are in two image streams (left and right), each at one times the frame rate. Left and right images 2702 are frame rate converted and interleaved at 2704 by a framestore memory and controller. This results in frame-interleaved left and right images 2706, provided in a single image stream (frame-interleaved left and right images at double frame rate).

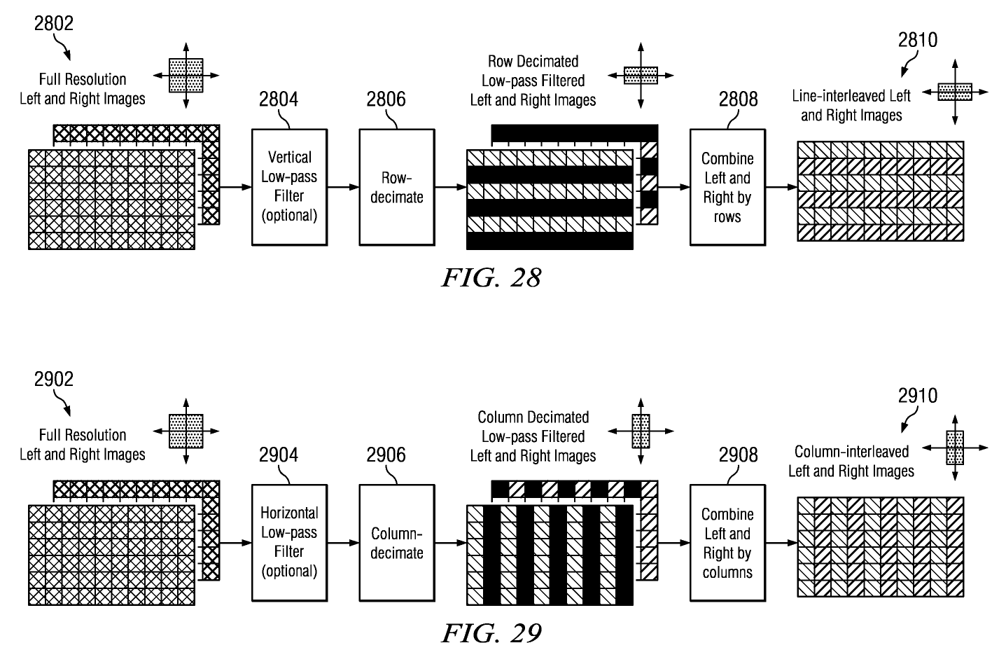

FIG. 28 is a schematic diagram illustrating a stereoscopic image processing conversion technique from full bandwidth left and right images to line interleaved format. In accordance with this embodiment, full resolution left and right images 2802 are optionally vertically low-pass filtered at 2804, then row decimated at 2806. Alternating rows of left and right images may then be combined at 2808 to generate line-interleaved left and right images 2810.

FIG. 29 is a schematic diagram illustrating a stereoscopic image processing conversion technique from full bandwidth left and right images to column interleaved format. Here, full resolution left and right images 2902 are optionally horizontally low-pass filtered at 2904, then column decimated at 2906. Alternating columns of left and right images may then be combined at 2908 to generate column-interleaved left and right images 2910.

FIG. 30 is a schematic diagram illustrating a stereoscopic image processing conversion technique from full bandwidth left and right images to frame interleaved format. In this embodiment, full resolution left and right images 3002 are in two image streams (left and right), each at one times the frame rate. Left and right images 3002 are frame rate converted and interleaved at 3004 by a framestore memory and controller. This results in frame-interleaved left and right images 3006, provided in a single image stream (frame-interleaved left and right images at double frame rate).

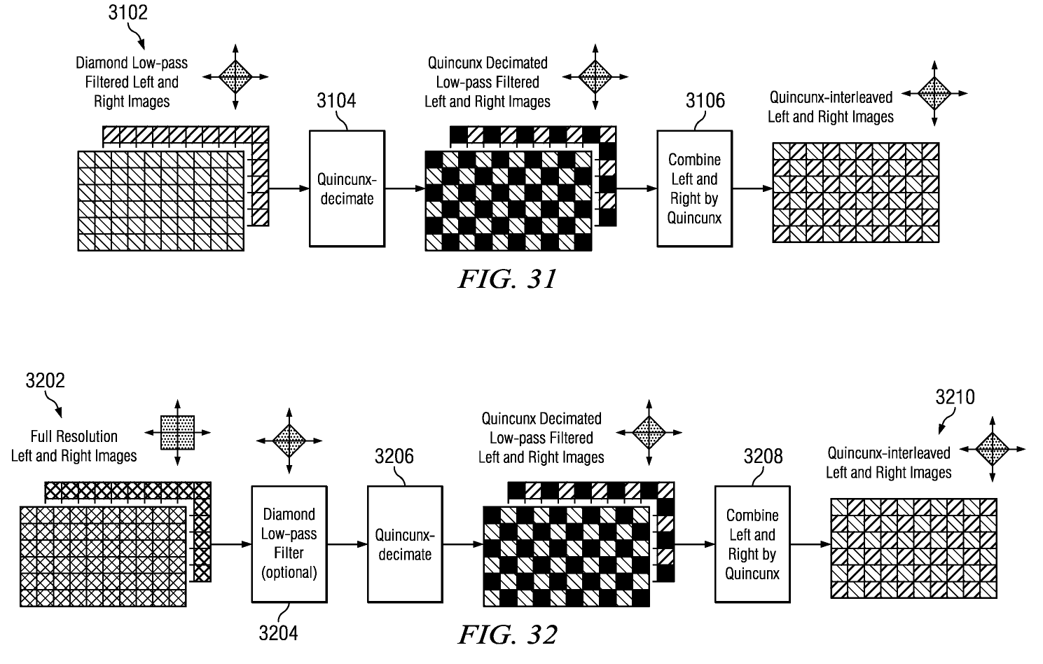

FIG. 31 is a schematic diagram illustrating a stereoscopic image processing conversion technique from diamond low-pass filtered left and right images to DLP Diamond format. In operation, diamond low-pass filtered left and right images 3102 are quincunx-decimated at 3104, then are combined by a quincunx technique (at 3106) to provide quincunx-interleaved left and right images 3108.

FIG. 32 is a schematic diagram illustrating a stereoscopic image processing conversion technique from full bandwidth left and right images to DLP Diamond format. Here, in operation, full resolution left and right images 3202 are optionally diamond low-pass filtered at 3204, then quincunx-decimated at 3206, then are combined by a quincunx technique (at 3208) to provide quincunx-interleaved left and right images 3210.

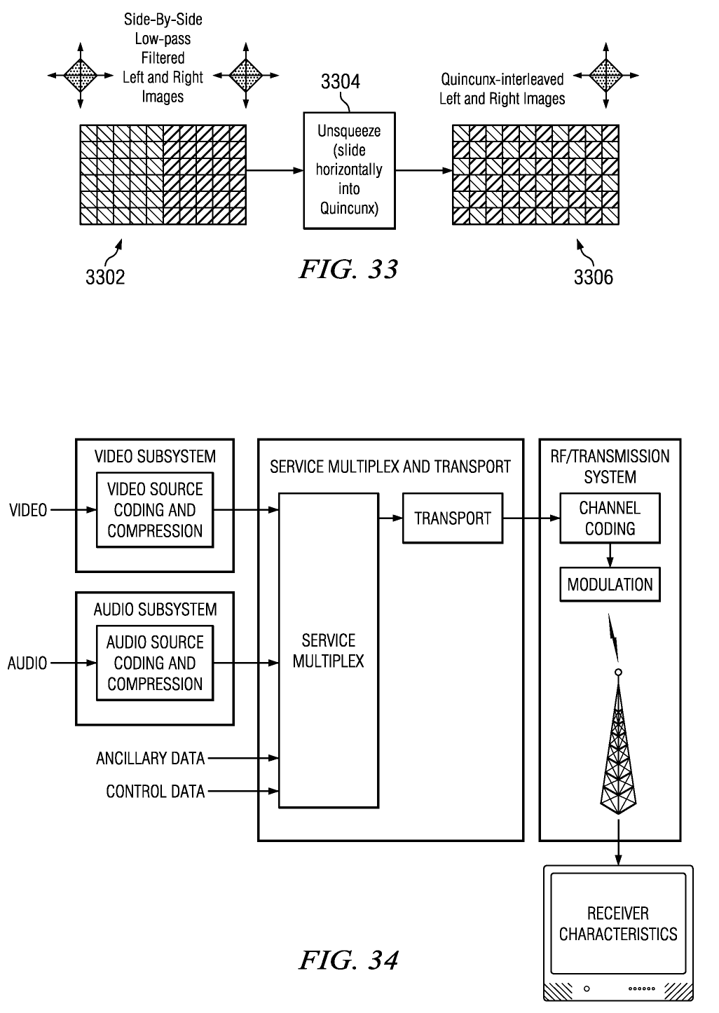

FIG. 33 is a schematic diagram illustrating a stereoscopic image processing conversion technique from side-by-side diamond filtered left and right images to DLP Diamond format. In this embodiment, side-by-side low-pass filtered left and right images 3302 are unsqueezed (slid horizontally into quincunx) at 3304 to generate quincunx-interleaved left and right images 3306.

When optical disc formats, such as Blu-Ray Disc, HD-DVD, or DVD are used to store the format described herein, one embodiment is to carry Base Layer as the normal video stream and the Enhancement Layer data as an Alternate View video stream. In current equipments, this Enhancement data will be ignored by the player, allowing backwards compatibility with current systems while providing a high quality image using the base layer. Future players and systems can use the Enhancement Layer data to recover substantially full cardinally sampled resolution images.

Current signaling systems may indicate whether a given frame in a temporally multiplexed (frame or field interleaved) stereoscopic image stream is a left image, a right image, or a 2D (mono) image, as disclosed by Lipton et al in U.S. Pat. No. 5,572,250, herein incorporated by reference. These signaling systems are described as ‘in-band,’ meaning they use pixels in the active viewing area of the image to carry the signal, replacing the image visual data with the signal. This can result in a loss of up to one or more lines (rows) of image data. An embodiment described herein includes an additional enhancement layer to carry the image pixel data lost in the signaling system, providing for full resolution pictures as well as the signaling capability.

An alternate embodiment for carrying the left/right and stereo/mono signaling is to use metadata (e.g. an additional data stream containing information or instructions on how to interpret the image data) and to leave image data substantially intact. This metadata stream can also be used to carry information such as 3D subtitles, menu instructions, and other 3D-related data essence and functionalities.

It will be appreciated that the invention(s) can be embodied in other specific forms without departing from the spirit or essential character thereof. Any disclosed embodiment may be combined with one or several of the other embodiments shown and/or described. This is also possible for one or more features of the embodiments. The steps herein described and claimed do not need to be executed in the given order. The steps can be carried out, at least to a certain extent, in any other order.

As one of ordinary skill in the art will appreciate, the terms “operably coupled” and “communicatively coupled,” as may be used herein, include direct coupling and indirect coupling via another component, element, circuit, or module where, for indirect coupling, the intervening component, element, circuit, or module does not modify the information of a signal but may adjust its current level, voltage level, and/or power level.

Further, it will be appreciated that the presently disclosed embodiments are considered in all respects to be illustrative and not restrictive. The scope of the invention is indicated by the appended claims rather than the foregoing description, and all changes that come within the meaning and ranges of equivalents thereof are intended to be embraced therein.

Additionally, the section headings herein are provided for consistency or otherwise to provide organizational cues. These headings shall not limit or characterize the invention(s) set out in any claims that may issue from this disclosure. Specifically and by way of example, although the headings refer to a “Technical Field,” the claims should not be limited by the language chosen under this heading to describe the so-called technical field. Further, a description of a technology in the “Background” is not to be construed as an admission that technology is prior art to any invention(s) in this disclosure. Neither is the “Brief Summary” to be considered as a characterization of the invention(s) set forth in the claims found herein. Furthermore, any reference in this disclosure to “invention” in the singular should not be used to argue that there is only a single point of novelty claimed in this disclosure. Multiple inventions may be set forth according to the limitations of the multiple claims associated with this disclosure, and the claims accordingly define the invention(s), and their equivalents, that are protected thereby. In all instances, the scope of the claims shall be considered on their own merits in light of the specification, but should not be constrained by the headings set forth herein.

What is claimed is:

1. A method for encoding stereoscopic images, comprising:
receiving a stereoscopic video sequence;
generating stereoscopic base layer video from the stereoscopic video sequence; and
generating stereoscopic enhancement layer video from the stereoscopic video sequence.

2. The method of claim 1:
wherein generating stereoscopic base layer video comprises low-pass filtering the stereoscopic video sequence, and
wherein generating stereoscopic enhancement layer video comprises high-pass filtering the stereoscopic video sequence.

3. The method of claim 1, further comprising:
compressing the stereoscopic base layer video to a compressed stereoscopic base layer, and compressing the stereoscopic enhancement layer video to a compressed stereoscopic enhancement layer.

4. The method of claim 3, further comprising:
generating an output bitstream comprising the stereoscopic base layer and the compressed stereoscopic enhancement layer.

5. The method of claim 4, further comprising:
generating the output bitstream further comprising at least one of audio data, and left and right image depth information.

6. The method of claim 1, wherein generating stereoscopic enhancement layer video comprises determining a difference between the stereoscopic video sequence and the stereoscopic base layer video.

7. The method of claim 5, further comprising distributing the output bitstream via a distribution medium selected from the group comprising:
read-only memory discs, terrestrial broadcasting, satellite broadcasting, cable broadcasting, internet streaming, and internet file transfer.

8. A method for encoding a stereoscopic signal, comprising:
receiving a stereoscopic video sequence;
generating stereoscopic base layer video from the stereoscopic video sequence;
compressing the stereoscopic base layer video to a compressed stereoscopic base layer;
generating stereoscopic enhancement layer video from the difference between the stereoscopic video sequence and the stereoscopic base layer video; and
compressing the stereoscopic enhancement layer video to a compressed stereoscopic enhancement layer.

9. The method of claim 8:
wherein generating stereoscopic base layer video comprises low-pass filtering the stereoscopic video sequence, and
wherein generating stereoscopic enhancement layer video comprises high-pass filtering the stereoscopic video sequence.

10. The method of claim 8, further comprising:
generating an output bitstream from the compressed stereoscopic base layer and the compressed stereoscopic enhancement layer.

11. The method of claim 8, further comprising:
generating an output bitstream from:
the compressed stereoscopic base layer and the compressed stereoscopic enhancement layer, and
at least one of audio data, and left and right image depth information.

12. The method of claim 11, further comprising distributing the output bitstream via a distribution medium selected from the group comprising:
read-only memory disc, electronic physical memory storage media, terrestrial broadcasting, satellite broadcasting, cable broadcasting, internet streaming, and internet file transfer.

13. An apparatus for selectively decoding a stereoscopic signal having stereoscopic base layer video and stereoscopic enhancement layer video components, comprising:
an extraction module operable to receive an input bitstream and extract from the input bitstream compressed stereoscopic base layer video and compressed stereoscopic enhancement layer video;
a first decompressing module operable to decompress the compressed stereoscopic base layer video into stereoscopic base layer video; and
a second decompressing module operable to decompress the compressed stereoscopic enhancement layer video signal into stereoscopic enhancement layer video.

14. The apparatus of claim 13, further comprising:
a combining module,
operable in a first mode to generate a stereo video sequence from the stereoscopic base layer video and not the stereoscopic enhancement layer video, and
operable in a second mode to generate a stereo video sequence from both the stereoscopic base layer video and the stereoscopic enhancement layer video.

15. The apparatus of claim 14, wherein the extraction module is further operable to extract audio data from the input bitstream.

16. The apparatus of claim 14, wherein the extraction module is further operable to extract a content information tag from the input bitstream.

17. The apparatus of claim 14, further comprising a mode selection module operable to detect when communicatively coupled stereoscopic audiovisual equipment is compatible with one of the first mode and the second mode.

18. The apparatus of claim 17, wherein the mode detection module determines operation in the first mode and the second mode based upon user-defined settings of communicatively coupled stereoscopic equipment.

19. The apparatus of claim 17, wherein the mode detection module determines operation in the first mode and the second mode based upon a detection of communicatively coupled stereoscopic equipment.

20. The apparatus of claim 13, further comprising a receiver for receiving the input bitstream from a distribution medium selected from the group comprising:
read-only memory discs, electronic physical memory storage media, terrestrial broadcasting, satellite broadcasting, cable broadcasting, internet streaming, and internet file transfer.
